(19) United States
(12) Patent Application Publication
(10) Pub. No.: US 2020/0083541 A1
(43) Pub. Date: Mar. 12, 2020

(54) ELECTROCHEMICAL CELLS FOR USE WITH GAS MIXTURES

(71) Applicant: AQUAHYDREX PTY LTD, New South Wales (AU)

(72) Inventors: Gerhard Frederick SWIEGERS, New South Wales (AU); Klaudia Katarzyna WAGNER, New South Wales (AU); Prerna TIWARI, New South Wales (AU); Paul BARRETT, New South Wales (AU)

(73) Assignee: AQUAHYDREX PTY LTD, New South Wales (AU)

(21) Appl. No.: 16/615,616

(22) PCT Filed: May 25, 2018
(86) PCT No.: PCT/AU2018/050508

§ 371 Date: Nov. 21, 2019

Related U.S. Application Data
(60) Provisional application No. 62/511,646, filed on May 26, 2017.
(60) Provisional application No. 62/511,662, filed on May 26, 2017.

(51) Int. Cl. H01M 4/88; B01D 53/22; C01B 3/50; C25B 11/03; H01M 8/0239; H01M 8/083; B60L 50/72; C25B 9/08; B01D 71/36

(52) U.S. Cl. CPC H01M 4/8807; B01D 53/228; C01B 3/50; C25B 11/035; H01M 8/0239; H01M 8/083; B01D 2325/10; C25B 9/08; B01D 71/36; B01D 2256/16; B01D 2257/7025; H01M 2300/0014; B60L 50/72

(57) ABSTRACT

Electrochemical cells (e.g., fuel cells or electrochemical gas extraction cells) supplied with power-to-gas mixtures of dilute hydrogen concentrations may be remarkably improved by the use of porous gas layer electrodes. The electrochemical cells may comprise a first porous gas layer gas diffusion electrode, a second porous gas layer gas diffusion electrode, and a liquid electrolyte Sin contact with the first and second electrodes. The porous gas layers may each comprise a porous, non-conductive, liquid-impermeable material that dramatically improves cell performance.

### TECHNICAL FIELD

This application relates to electrochemical cells, modules and/or reactors that are capable of generating electrical energy or extracting hydrogen gas from a hydrogen-containing gas mixture.

### BACKGROUND

Blending hydrogen into the existing natural gas pipeline network in a “Power-to-Gas” (P2G) technology is presently being actively pursued as a means of increasing the deployment on electrical grids of renewable energy sources like biomass, solar or wind. Not only does P2G help balance such electrical grids, but it also allows for an improved utilization of renewable resources that often generate power when it is least needed. The natural gas network also offers a potentially vast storage medium for renewable hydrogen. In the USA alone, the natural gas network includes 2.44 million miles of pipe.

As a practical outcome of the P2G strategy, it may be anticipated that future natural gas distribution networks will routinely contain at least a small proportion of hydrogen. Based on current trends, the concentration of hydrogen gas distributed in natural gas pipelines is likely to be equal to or less than 10% by volume of the gas mixture for some time.

If such hydrogen-enriched natural gas can be conveniently used to generate electricity, this would provide additional economic benefits. A fuel cell that could utilize such a blend would, however, need to operate successfully and sustainably at the low levels of hydrogen that will be present in the 10% or less hydrogen-enriched methane mixtures that may be expected from P2G. In short, the fuel cell would have to be capable of utilising such hydrogen blends as a fuel. However, existing fuel cell technologies are incapable of operating efficiently with fuel mixtures containing such low concentrations of hydrogen.

Blending hydrogen into natural gas pipeline networks has also been proposed as a means of delivering pure renewable hydrogen to markets, relying on the use of separation and/or purification technologies to extract the hydrogen close to the at consuming endpoints. However, existing extraction techniques are incapable of efficiently extracting hydrogen from mixtures with low concentrations of hydrogen (e.g., below about 10%).

### SUMMARY

This Summary is provided to introduce a selection of concepts in a simplified form that are further described below in the Examples. This Summary is not intended to identify all of the key features or essential features of the claimed subject matter, nor is it intended to be used to limit the scope of the claimed subject matter.

In one example, there is provided an electrochemical cell for extracting hydrogen gas from a gas mixture, the electrochemical cell comprising a first gas diffusion electrode comprising a first non-conductive hydrophobic porous gas layer and a first conductive catalyst, and a second gas diffusion electrode comprising a second non-conductive hydrophobic porous gas layer and a second conductive catalyst. In one embodiment, a liquid electrolyte is in contact with the first conductive catalyst and the second conductive catalyst. In another embodiment, a first gas chamber is adjacent to the first porous gas layer, containing a supplied gas mixture of hydrogen gas and a second gas. In another embodiment, in addition or alternatively, a second gas chamber is adjacent to the second porous gas layer, containing pure hydrogen gas.

In a particular non-limiting example, the electrolyte is a proton-diffusing liquid. In another particular non-limiting example, the electrolyte comprises an acid. In another particular non-limiting example, the electrolyte comprises an acid in an aqueous solution. In another particular non-limiting example, the acid is H₂SO₄. In another particular non-limiting example, the porous, liquid-impermeable material is expanded polytetrafluoroethylene (ePTFE). In another particular non-limiting example, the first conductive catalyst is part of a conductive layer separate from the first porous gas layer, the conductive layer contacting a surface of the porous gas layer in contact with the electrolyte. In another particular non-limiting example, the first catalyst or the second catalyst is directly supported on a portion of the respective porous gas layer. In another particular non-limiting example, the first electrode is structurally or compositionally different than the second electrode. In another particular non-limiting example, the first electrode is structurally and compositionally identical to the second electrode. In another particular non-limiting example, there is not any ion-permeable diaphragm or ionomer positioned between the first and second electrodes. In another particular non-limiting example, the electrochemical cell further comprises an electrical power source electrically connected to the first and second electrodes.

In another particular non-limiting example, the first electrode is an anode at which hydrogen gas is consumed by oxidation, and wherein the second electrode is a cathode at which hydrogen gas is produced by reduction. In another particular non-limiting example, there is provided a mechanism for controlling the rate of supply of the gas mixture to the anode. In another particular non-limiting example, there is provided a mechanism for controlling pressures in the first and second gas chambers. In another particular non-limiting example, the second gas chamber has a fixed volume and a pressure regulator at an out-flow conduit. In another particular non-limiting example, the second gas chamber is sized and configured to store the pure hydrogen gas at a pressure greater than a pressure of the supplied gas mixture. In another particular non-limiting example, the pure hydrogen gas in the second gas chamber is at a steady pressure of at least 0.5 bar greater than a pressure of the supplied gas mixture. In another particular non-limiting example, the gas mixture comprises hydrogen gas and natural gas. In another particular non-limiting example, the gas mixture comprises hydrogen gas with a concentration of between about 5% and about 10%, by volume of the gas mixture.

In another example, there is provided a method of extracting hydrogen gas from a gas mixture, the method comprising the steps of supplying a gas mixture containing hydrogen gas and a second gas to a first gas chamber of an electrochemical cell, the first gas chamber containing a first electrode having a first non-conductive hydrophobic porous gas layer and a first conductive catalyst electrically connected to a first terminal. In one embodiment, an electric potential difference is applied between the first terminal and a second terminal of the electrochemical cell. In another embodiment, the second terminal is electrically connected to a conductive catalyst of a second electrode having a second porous gas layer and positioned in a second gas chamber. In another embodiment, a produced flow of pure hydrogen gas is extracted from the second gas chamber.

In another particular non-limiting example, extracting of the pure hydrogen gas is at a pressure greater than a pressure at which the gas mixture is supplied to the first gas chamber. In another particular non-limiting example, the gas mixture comprises natural gas mixed with the hydrogen gas. In another particular non-limiting example, the gas mixture has a hydrogen gas concentration of less than 10% by volume of the gas mixture.

In another example, there is provided a fuel cell for generating electrical energy from a gas mixture comprising hydrogen gas, the fuel cell comprising a first gas diffusion electrode comprising a first non-conductive hydrophobic porous gas layer and a first conductive catalyst, and a second gas diffusion electrode comprising a second non-conductive hydrophobic porous gas layer and a second conductive catalyst. In one embodiment, a liquid electrolyte is in contact with the first conductive catalyst and the second conductive catalyst. In another embodiment, a first gas chamber is adjacent to the first porous gas layer, containing a first supplied gas mixture of hydrogen gas and a second gas. In another embodiment, a second gas chamber is adjacent to the second porous gas layer, containing a second gas mixture.

In another particular non-limiting example of a fuel cell, the electrolyte is an aqueous alkaline solution. In another particular non-limiting example of a fuel cell, the electrolyte comprises KOH. In another particular non-limiting example of a fuel cell, the porous, liquid-impermeable material is expanded polytetrafluoroethylene (ePTFE). In another particular non-limiting example of a fuel cell, each of the first and second electrodes comprises a catalyst, wherein the catalyst is coated on a surface in contact with the electrolyte. In another particular non-limiting example of a fuel cell, there is provided a mechanism for controlling a rate of supply of the gas mixture to the first gas diffusion electrode. In another particular non-limiting example of a fuel cell, the second gas mixture contains oxygen. In another particular non-limiting example of a fuel cell, there is provided a mechanism for controlling a rate of supply of the second gas mixture to the cathode. In another particular non-limiting example of a fuel cell, the first gas mixture comprises hydrogen gas and natural gas. In another particular non-limiting example of a fuel cell, the first gas mixture comprises hydrogen gas in a concentration of between about 5% and about 10% by volume of the first gas mixture. In another particular non-limiting example of a fuel cell, the first conductive catalyst is part of a conductive layer separate from the first porous gas layer, the conductive layer contacting a surface of the porous gas layer in contact with the electrolyte. In another particular non-limiting example of a fuel cell, the first catalyst or the second catalyst is directly supported on a portion of the respective porous gas layer.

In another example, there is provided a method of generating electrical energy from a gas mixture, the method comprising supplying a first gas mixture containing hydrogen gas and a second gas to a first gas chamber of an electrochemical cell, the first gas chamber containing a first electrode having a first non-conductive hydrophobic porous gas layer and a first conductive catalyst electrically connected to a first terminal. In one embodiment, a second gas mixture containing oxygen gas is supplied to a second gas chamber of the electrochemical cell, the second gas chamber containing a second electrode having a second non-conductive hydrophobic porous gas layer and a second conductive catalyst electrically connected to a second terminal. In another embodiment, an electrical load is applied between the first and second terminals.

In another particular non-limiting example, the first gas mixture has a concentration of hydrogen less than about 10%. In another particular non-limiting example, the method includes monitoring a concentration of hydrogen in the first gas mixture, increasing a rate of supply of the gas mixture to the first electrode in response to detecting a decreased concentration of the hydrogen gas in the first gas mixture.

In one example, there is provided a fuel cell for generating electrical energy from a gas mixture comprising hydrogen gas, the fuel cell comprising: a first gas diffusion electrode; a second gas diffusion electrode; and a liquid electrolyte in contact with the first and second electrodes. In one embodiment, each of the first and second electrodes comprises a layer comprising a porous, liquid-impermeable material.

Optionally, the electrolyte may be an alkaline electrolyte or it may be an acid electrolyte. Optionally, the electrolyte may further be a neutral electrolyte that is neither, or only partly acid or base.

In another example, there is provided a method of generating electrical energy from a gas mixture comprising hydrogen gas, the method comprising the steps of: providing a fuel cell comprising: a first gas diffusion electrode; a second gas diffusion electrode; and a liquid electrolyte in contact with the first and second electrodes; wherein each of the first and second electrodes comprises a layer comprising a porous, liquid-impermeable material. In one embodiment, the first electrode is an anode, the second electrode is a cathode, In another embodiment, the method includes the steps of supplying the gas mixture to the first electrode and supplying oxygen gas to the second electrode.

In another example, there is provided an electrochemical cell for extracting hydrogen gas from a gas mixture, the electrochemical cell comprising: a first gas diffusion electrode; a second gas diffusion electrode; and a liquid electrolyte in contact with the first and second electrodes. In one embodiment, each of the first and second electrodes comprises a layer comprising a porous, liquid-impermeable material.

In another example, there is provided a method of extracting hydrogen gas from a gas mixture, the method comprising the steps of: providing an electrochemical cell comprising: a first gas diffusion electrode; a second gas diffusion electrode; and a liquid electrolyte in contact with the first and second electrodes; wherein each of the first and second electrodes comprises a layer comprising a porous, liquid-impermeable material; and supplying an electric potential difference between the first and second electrodes. In one embodiment, the first electrode is an anode, and the second electrode is a cathode.

In another embodiment, the method includes supplying the gas mixture to the first electrode and collecting a gas product from the second electrode, wherein the gas product is a product of electrochemical reactions occurring within the electrochemical cell.

### BRIEF DESCRIPTION OF THE DRAWINGS

Although various example embodiments will be apparent from the following Detailed Description, such example embodiments are not intended to limit the scope of the invention, which is only to be limited by the Claims. The description of various illustrative example embodiments set forth in the following Detailed Description may make reference to the attached drawings, of which:

FIG. 1 is a schematic illustration of: (A) an example gas diffusion electrode comprising a porous gas layer directly supporting a catalyst material; (B) an example gas diffusion electrode comprising a porous gas layer electrode combined with a conductive catalyst layer and an optional membrane layer; and (C) an example fuel cell for generating electrical energy from a gas mixture comprising hydrogen gas.

FIG. 2 illustrates a table containing parameters relating to gas flow and electrical properties observed during experiments with an example fuel cell.

FIG. 3 illustrates an example of a typical fuel cell voltage-current density characteristic, (j-V).

FIG. 4 illustrates measured polarization (j-V) and power density-current density (j-P) curves for an example fuel cell operating with gas mixtures having hydrogen gas concentrations between 5% and 100%, by volume.

FIG. 5 illustrates polarization curves for an example fuel cell operating with pure hydrogen. The curves illustrate uncorrected data (dashed line), and data corrected by: (i) taking into account the electrolyte resistance (solid, black line) and (ii) using electrochemical impedance spectroscopy (solid, grey line).

FIG. 6 illustrates Tafel plots for an example fuel cell operating with hydrogen gas and methane gas mixtures having hydrogen gas concentrations between 5% and 100%, by volume.

FIG. 7 illustrates a table containing parameters obtained from the Tafel plots of FIG. 6. These parameters include slope A, and the exchange current density iₒ. The table further includes parameters relating to electrochemical impedance including double-layer capacitance within the catalyst layer C_{(ct)}, charge transfer resistance R_{(ct)}, and diffusional resistance Z_{(d)}.

FIG. 8 illustrates Nyquist plots of symmetrically supplied hydrogen (H₂/H₂, solid black line), oxygen (O₂/O₂, solid grey line) and hydrogen/oxygen (H₂/O₂, dashed line), at the two electrodes of an example fuel cell, at open circuit potential (OCV).

FIG. 9 illustrates Bode plots of symmetrically supplied hydrogen (H₂/H₂, solid black line), oxygen (O₂/O₂, solid grey line), and hydrogen/oxygen (H₂/O₂, dashed line) at the two electrodes of an example fuel cell, st open circuit potential (OCV).

FIG. 10 illustrates a table listing charge transfer resistance (R_{ct}), double layer capacitance (C_{ct}), exchange current density (iₒ) and relaxation time tₒ for an example fuel cell.

FIG. 11 illustrates an equivalent circuit for an example fuel cell.

FIG. 12 illustrates Nyquist spectra of impedance measurements for an example fuel cell supplied with pure hydrogen and with a hydrogen and methane gas mixture having hydrogen concentrations of 50%, 40%, 30%, 20%, 10%, and 5%.

FIG. 13 illustrates an equivalent circuit for an example fuel cell.

FIG. 14 illustrates measured polarization (j-V) and power density-current density (j-P) characteristics for an example fuel cell operating with pure hydrogen before (solid lines, black for j-V and grey for j-P) and after measurements with hydrogen and methane mixtures.

FIG. 15 illustrates electrochemical impedance spectroscopy measurements at a constant 10 mA/cm² current density, for an example fuel cell.

FIG. 16 illustrates a table containing parameters relating to gas flow and electrical properties observed during experiments with an example fuel cell.

FIG. 17 illustrates measured polarization (j-V) and power density-current density (j-P) curves for an example fuel cell operating with gas mixtures having hydrogen gas concentrations between 5% and 100%, by volume.

FIG. 18 illustrates galvanostatic electrochemical impedance spectroscopy measurements at 10 mA/cm² current density, for an example fuel cell operating with: 100%, 5%, 4%, 3% and 2% hydrogen concentration in an input gas mixture.

FIG. 19 illustrates a plot of fuel utilisation versus cell potential for an example fuel cell supplied with pure hydrogen and with a hydrogen and methane gas mixture having hydrogen concentrations of 100%, 5%, 4%, 3%, and 2%, by volume.

FIG. 20 illustrates an example electrochemical cell for extracting hydrogen gas from a gas mixture.

FIG. 21 illustrates cyclic voltammograms of the hydrogen oxidation and evolution reactions in 1 M H₂SO₄ on a 0.5 g m⁻² Pt loaded, carbon black electrode in an example fuel cell configuration without hydrogen flow; potential controlled versus Ag/AgCl; counter electrode: 0.5 g m⁻² Pt loaded carbon black; scan rate 50 mV/s.

FIG. 22 illustrates chronoamperograms of an example three-electrode system with applied potential between −0.2 V and 0.4 V.

FIG. 23 illustrates chronoamperograms of the example three-electrode system of FIG. 22, for the potential 0.4 V with 100% hydrogen flow at 10 ml/min to the anode and after switching off the flow.

FIG. 24 illustrates a table of current (i) measured under different potentials (E) and η_{cell} (a measure of cell efficiency) calculated from the recovered hydrogen Hᵣ and theoretically produced hydrogen Hₚ on the basis of the current intensity in a first measurement (Run 1) and a second measurement (Run 2) for an example two-electrode system (i.e. electrochemical cell).

FIG. 25 illustrates chronoamperograms for an applied potential between 0.1 V and 1 V, in the two-electrode system of FIG. 24, controlled versus the cathode as a reference, for the first set of measurements (Run 1) of FIG. 24.

FIG. 26 illustrates chronoamperograms for an applied potential between 0.1 V and 1 V, in the two-electrode system of FIG. 24, controlled versus the cathode as a reference, for the second set of measurements (Run 2) of FIG. 24.

FIG. 27 illustrates a plot of current density versus potential with bubbles that correspond to the ml/min of recovered hydrogen for the two-electrode system of FIG. 24.

FIG. 28 illustrates Nyquist spectrum of impedance before electrochemical purification Run1 (dashed line, I) and after Run 2 (solid line II), for the two-electrode system of FIG. 24, with a cell voltage of 0.1 V versus cathode.

FIG. 29 illustrates a table showing flow parameters for a H₂ and CH₄ gas mixture.

FIG. 30 illustrates measured current-potential curves obtained for the different gas mixtures of FIG. 29, for an example electrochemical cell.

FIG. 31 illustrates measured hydrogen recovery Hᵣ rates, in ml/min, of the gas mixtures of FIG. 29 at the different potentials, for an example electrochemical cell. There is a measurement vertical error of ±0.1 ml/min.

FIG. 32 illustrates measured hydrogen yield η_{H} at different potentials, for an example electrochemical cell.

FIG. 33 illustrates measured cell efficiency η_{cell} at different potentials, for an example electrochemical cell.

FIG. 34 illustrates a table showing flow parameters for a H₂ and CH₄ gas mixture.

FIG. 35 illustrates measured current-potential curves obtained for the different gas mixtures of FIG. 34, for an example electrochemical cell.

FIG. 36 illustrates the current-potential curves of FIG. 35, with bubbles corresponding to the recovery rate of hydrogen, in ml/min of Hᵣ, for an example electrochemical cell.

FIG. 37 illustrates measured cell efficiency η_{cell} at different potentials, for an example electrochemical cell.

FIG. 38 illustrates a table showing flow parameters for a H₂ and CH₄ gas mixture.

FIG. 39 illustrates measured current-potential curves obtained for the different gas mixtures of FIG. 38, for an example electrochemical cell, with bubbles corresponding to the recovery rate of hydrogen, in the ml/min of Hᵣ.

FIG. 40 illustrates measured hydrogen yield η_{H} at different potentials, for an example electrochemical cell.

FIG. 41 illustrates measured cell efficiency η_{cell} the different potentials, for an example electrochemical cell.

FIG. 42 illustrates polarization curves for pure hydrogen gas at the anode and mixtures with methane between 100% and 5% (295 K, 1 atm, Pt catalyst, 2.5 ml/min).

FIG. 43 illustrates Nyquist spectra of impedance measurements for an example electrochemical cell supplied with 100% hydrogen gas, with hydrogen flow kept at 2.5 ml/min, at cell voltages of 0.1 V, 0.2 V, 0.3 V and 0.4 V versus cathode.

FIG. 44 illustrates Nyquist spectra of impedance measurements for an example electrochemical cell supplied with a 5% hydrogen-methane mixture, with hydrogen flow kept at 2.5 ml/min, at cell voltages of 0.1 V, 0.2 V, 0.3 V and 0.4 V versus cathode.

FIG. 45 illustrates a table listing equivalent circuit resistance and capacitance values obtained with the from the curve fits of FIG. 44.

FIG. 46 illustrates a plot of equivalent circuit resistance values calculated for different cell voltages.

FIG. 47 illustrates an example method for preparing a catalyst-coated porous gas layer membrane comprising an ePTFE membrane, a catalyst slurry, and a metallic mesh.

FIG. 48 illustrates the preparation of example laminate-mounted electrodes.

FIG. 49 illustrates a photograph of an example electrochemical cell prior to assemblage.

FIG. 50 illustrates a photograph of the example electrochemical cell of FIG. 22, after assemblage.

FIG. 51 illustrates cross-sectional schematics of an example embodiment fuel cell showing electrical and gas connections.

FIG. 52 illustrates a cross-sectional schematic of an example embodiment gas extraction cell showing electrical and gas connections.

### DETAILED DESCRIPTION

The following modes, features or aspects, given by way of example only, are described in order to provide a more precise understanding of the subject matter of a preferred embodiment or embodiments.

Various embodiments herein provide electrochemical cells configured to efficiently make use of gas mixtures containing at least low concentrations of hydrogen in addition to other gases. Several example embodiments are described with reference to natural gas mixtures containing up to 10% hydrogen gas. Nonetheless, the principles, structures, and methods described herein may be applied to systems utilizing higher hydrogen gas concentrations or mixtures of hydrogen gas with gases other than natural gas.

### INTRODUCTION

The unique cells described herein are generally characterized by positive and/or negative electrodes comprising at least one “porous gas layer” that enhances transport of gases to and/or from a reaction site within an electrode. A porous gas layer (also referred to herein as a “PGL”) is generally a porous hydrophobic material that is impermeable to liquid electrolytes but remains highly permeable to gases. Porous gas layer electrodes may take several forms as described in various embodiments herein. In particular examples, a porous gas layer can also be non-conductive, thereby providing a non-conductive hydrophobic porous gas layer.

Experimental results (described below) have shown that, when used in electrochemical hydrogen extraction cells and fuel cells producing energy from low-concentration hydrogen gas fuel mixtures, porous gas layer electrodes perform at dramatically higher efficiencies than electrodes relying on conventional technologies.

Without wishing to be held to any particular theories, it is believed that the dramatic improvements are due to the porous gas layer electrodes providing an unexpectedly active solid-liquid interface for both gas extraction and gas-to-energy conversion. The highly active interface in concert with high ion conduction by the aqueous electrolyte, allow for highly efficient and selective utilization of dilute hydrogen. The porous gas layer electrodes are also substantially improved by decreased interference from gas bubbles, decreased bubble overpotential, and decreased inter-electrode resistances. Cells utilizing porous gas layer electrodes with dilute hydrogen mixtures are significantly more efficient than conventionally available technologies as is illustrated in the example experimental results provided herein. These and other advantages will be better understood from the following detailed descriptions.

### Definitions

A gas diffusion electrode may act to transport a gas generated at the electrode out of an electrochemical cell; alternatively, a gas diffusion electrode may act to transport gas into an electrochemical cell, from the outside of the cell. To this end, a gas diffusion electrode comprises one or more porous materials. A gas diffusion electrode may further comprise cavities or channels that allow for, or enable, the transport of gas.

A gas diffusion electrode is defined as an electrode with a conjunction of a solid, liquid and gaseous interface, and an electrical conducting catalyst supporting an electrochemical reaction between the liquid and gaseous phase. A “front” or “inter-electrode” side of the gas diffusion electrode interfaces with a liquid electrolyte and faces a counter-electrode. A “rear” or “outer” side of the electrode interfaces with a gas chamber that contains gas and no liquid. When installed in electrochemical cells, the “rear” or gas-side of a gas diffusion electrode is typically (but not exclusively) sealed against a frame or other cell structure to prevent liquid electrolyte from flooding the gas chamber. The region between the liquid-facing side and the gas-facing side of the electrode typically contains at least two layers, namely: (i) a conductive “catalyst” layer that faces the liquid electrolyte and abuts (ii) a “gas diffusion layer” that faces and is adjacent to the gas chamber.

For convenience, the conductive catalyst layer may be referred to as a “conductive layer” and the gas diffusion layer may be referred to as a “gas layer”. Liquid electrolyte typically penetrates somewhat but not all the way into the conductive layer. Gas from the gas side also penetrates through the gas diffusion layer into the catalyst layer from the back side.

The objective of this configuration is generally understood to create and maintain a three-phase solid-liquid-gas boundary (also referred to herein as the “three-phase boundary”) within the catalyst layer along a region at which the liquid electrolyte interfaces with the reactant/product gas in the presence of the solid catalyst. Reaction at the three-phase boundary is driven by electron flow to or from the current carrier, through the conductive catalyst and gas diffusion layers, causing either production or consumption of the gas.

Electrochemical cells of the types described herein may generally use liquid electrolytes. As used herein, the term “liquid electrolyte” may include acidic aqueous solutions, alkaline aqueous solutions, neutral or near-neutral pH aqueous solutions, deionized water, ionic liquids, or gel electrolytes (i.e., electrolyte solutions exhibiting cohesive properties similar to solids along with ionic diffusivity properties similar to liquids).

Various electrolytes may be used in combination with the electrodes and electrochemical cells described herein. For example, electrolytes used may include alkaline electrolytes such as potassium hydroxide (KOH), sodium hydroxide (NaOH), lithium hydroxide (LiOH), barium hydroxide (Ba(OH)₂), calcium hydroxide (Ca(OH)₂), or combinations of these or other aqueous bases. Electrolytes may also comprise acidic electrolytes such as hydrochloric acid (HCl), sulfuric acid (H₂SO₄), hydrobromic acid (HBr), nitric acid (HNO₃), chloric acid (HClO₃), perchloric acid (HClO₄), hydrofluoric acid (HF), phosphoric acid (H₃PO₄), or combinations of these and/or other acids. In other embodiments, electrolytes may comprise non-aqueous electrolytes, ionic liquid electrolytes, aqueous salt solution electrolytes, or mixtures or combinations of any of the above.

As used herein, a material that is described as “conductive” has a general property of being able to conduct electrons or electric current. In other words, a “conductive” material has a substantial degree of electrical conductivity. Such “conductive” materials may include materials generally known to be “semi-conductive” as well as those known to be “highly conductive.” In general, “conductive” materials should be understood to stand in contrast to “electrically insulative” or “electrically non-conductive” materials that do not generally conduct electrons under the operating conditions of the systems and materials described herein.

As the terms are used herein, a substance or material is defined to be ‘electroactive’ if it undergoes or facilitates electrochemical processes when subjected to a suitable voltage bias. A substance or material is ‘electro-inactive’ if it does not undergo or facilitate electrochemical processes when subjected to a suitable voltage bias.

Hydrophilicity and hydrophobicity are generally defined in terms of their “contact angle” with water. The term “contact angle” refers to an angle created by a liquid in contact with a solid surface. This angle is influenced by intermolecular cohesion and adhesion forces between the solid and the liquid as they interact. The balance between the cohesive forces of similar molecules such as between the liquid molecules (e.g., hydrogen bonds and Van der Waals forces) and the adhesive forces between dissimilar molecules such as between the liquid and solid molecules (e.g., mechanical and electrostatic forces) will determine the contact angle created in the solid-liquid interface. The traditional definition of a contact angle is the angle a liquid creates with the solid or liquid when the liquid is deposited on the solid.

As suggested above, the contact angle of a liquid with a solid material may partly depend on properties of the liquid as well as the material. Therefore, an aqueous electrolyte may have a different contact angle with a material than water at the same temperature.

Nonetheless, as the terms are used herein, a “hydrophilic” material is defined as having a contact angle with water that is less than or equal to 900 at standard temperature and pressure, while a “hydrophobic” material is defined as having a contact angle with water that is greater than 900 at standard temperature and pressure.

As used herein, the term “natural gas” refers broadly to any mixture of one or more flammable hydrocarbon gases typically distributed in natural gas pipelines or compressed and distributed as liquid natural gas (LNG). In some cases, specific hydrocarbon gases such as “methane” may be referenced herein. As used herein, references to “methane” and other such specific gases should be understood to be synonymous with “natural gas”, notwithstanding the fact that various natural gas mixtures may contain gases other than methane.

As used herein, the term “P2G gas” refers to a mixture of natural gas (as defined above) and hydrogen gas. Unless otherwise specified P2G gas may contain any measurable amount of hydrogen mixed with any mixture of “natural gas.”

### Porous Gas Layer Electrode Structures and Fabrication

Porous gas layer electrodes may take various forms and may be made by various processes. Broadly speaking, two types of porous gas layer electrodes will be described herein and may be used in any of the cells described herein. Porous gas layer electrodes of a first type comprise at least one layer of a porous gas layer material that directly supports a reaction catalyst. Porous gas layer electrodes of a second type comprise at least one porous gas layer combined with a separate layer of a different material that contains or supports a reaction catalyst.

In various embodiments, a porous gas layer may comprise a porous membrane of expanded polytetrafluoroethylene (ePTFE). Such ePTFE membranes are strongly hydrophobic porous materials that generate a repulsive capillary action in an electrode in a liquid electrolyte. Such membranes are manufactured commercially in numerous variants, each with a different average pore size and, in some cases, different hydrophobicities. Such ePTFE membranes are generally non-conductive to electrons and may alternatively be described as “electrically insulating.”

Other materials that may be suitable as porous gas layer materials may include MITEX, GORE-TEX, porous PVDF, porous polypropylene, porous polyethylene, porous Kynar, porous Hylar, porous polysulfones, porous polyethylsulfones, porous glasses, porous polyesters, fluoropore, Telsep, Polysep, Durapore, Biotrace, Fluorotrace, porous nylons, and porous fluoropolymers. Although ePTFE materials are referred to in various examples herein, any of the above materials may be substituted for the ePTFE membrane in any embodiment described or suggested herein. In some cases, the term “gortex” (a common mis-spelling of the brand name “GORE-TEX”) may be used herein as a generic term for any ePTFE materials useful as a porous gas layer. Materials referred to herein as “gortex” are not intended to be limited to products bearing the GORE-TEX trademark. The above gortex and other example porous gas layer materials may generally be considered to be electrically non-conductive or electrically insulative within the range of operating conditions of the cells and systems described herein.

When used as a porous gas layer in various example porous gas layer electrodes as described herein, such “gortex” or ePTFE (or other) materials may form a liquid-free gas chamber adjacent to the porous gas layer. A liquid-free gas chamber may be maintained adjacent to a porous gas layer by sealing the porous gas layer so as to prevent liquid ingress into the gas chamber. Various methods and/or structures for sealing such a gas chamber may be used.

A porous gas layer of an electrode may form a boundary between a liquid electrolyte and a gas chamber. In various embodiments, the location of the boundary within the thickness of a porous gas layer may depend on various factors such as a pressure applied to the liquid electrolyte, a gas pressure within the gas chamber, the porosity and/or hydrophobicity of the porous gas layer, or other factors. Therefore, as used herein, although the gas chamber is described as being “adjacent” to the porous gas layer, a liquid-free gas chamber region may extend partially into a thickness of the porous gas layer of an electrode. A liquid-free gas chamber region extending partially into a thickness of a porous gas layer is intended to be included within the use of the description of a gas chamber “adjacent to” a porous gas layer.

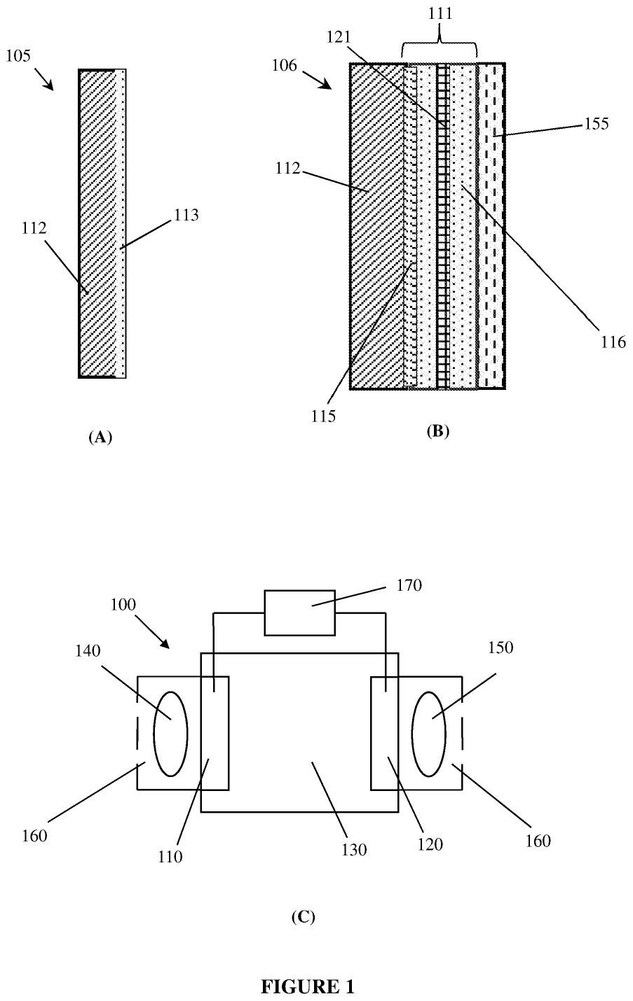

FIG. 1(A) schematically illustrates an example embodiment of a porous gas layer electrode 105 of the first type, having a porous gas layer 112 directly supporting a catalyst 113. In FIG. 1(A), the catalyst 113 is shown on one side of the porous gas layer 112 penetrating the porous gas layer 112 to only a partial depth. In other embodiments, the catalyst 113 may be distributed throughout the porous gas layer 112 or to any partial depth.

In various embodiments, the catalyst 113 may be deposited onto the porous gas layer 112 by any suitable process, such as sputtering, electrodeposition, spraying, painting, inkjet printing or other additive manufacturing techniques, screen printing methods, lithography, compression, doctor blading, extrusion, or wet paste application.

Additional example electrodes of the first type and methods of making them are shown and described in PCT Application Publications WO2013/185169, WO02013/185163, and WO2013/185170, each of which is incorporated herein by reference.

FIG. 1(B) schematically illustrates examples of porous gas layer electrodes 106 of the second type. The electrode 106 of FIG. 1(B) comprises a porous gas layer 112 and a conductive catalyst layer 111. In some embodiments, the conductive catalyst layer 111 may comprise one or more sections of a conductive substrate 121. The conductive layer 111 may also comprise a catalyst material 116 dispersed throughout the conductive layer 111. The catalyst material may be carried by a substrate 121 or may be substantially self-supporting. In some embodiments, the conductive layer 111 may comprise a binder 115.

In some embodiments, a catalyst material may be applied to a conductive substrate material, which may then be combined (e.g., by roller bonding, welding, compression, or other methods) with a porous gas layer to form a porous gas layer electrode. In some embodiments, a catalyst material may be applied to a porous gas layer and a conductive substrate material may then be combined with the porous gas layer to form an electrode.

In various embodiments, a conductive substrate may comprise a porous conductive material such as a woven metal mesh, a non-woven metal mesh, a perforated metal foil, a perforated metal sheet, a metal foam, a non-woven fibrous metal felt, an inert or non-conductive substrate coated with a metal, or other porous metal structure capable of carrying a catalyst. In various embodiments, a metal current collecting substrate may be made of one or more metals such as nickel, copper, titanium, aluminum, tin, zinc, or alloys or compounds of these or any other metals. In other embodiments, a current collecting substrate may comprise a carbon felt, a graphite felt, carbon nanotubes, a sintered porous carbon or graphite substrate, a woven or non-woven graphite mesh, or other porous conductive substrate structure capable of carrying a catalyst.

In various embodiments, a catalyst may be applied to a substrate by any suitable method, such as sputtering, electrodeposition, spraying, painting, inkjet printing or other additive manufacturing techniques, screen printing methods, lithography, compression, doctor blading, extrusion, or wet paste application. Some example processes are described in further detail below.

In some embodiments, a membrane 155 may be applied to a liquid-facing side of a conductive layer 111. In some embodiments, such a membrane 155 may comprise a hydrophilic porous polymer or cellulose material. For example, in some embodiments a membrane may comprise an unmodified polyethersulfone membrane or other sulfone material. In other embodiments, a membrane 155 may comprise a microporous polymer, a microporous polymer filled with an inorganic or other filler material, an ionomer, or other ion-selective separator membrane such as a sulfonated or perfluorinated membrane (e.g., NAFION). In other embodiments, a membrane 155 may be omitted from a cell entirely, relying only on a volume of a liquid electrolyte as an ion-conductive medium.

In various embodiments, a catalyst may include one or more metals and/or metal oxides, such as metals from the platinum group (platinum, ruthenium, rhodium, palladium, osmium, iridium), other noble metals (copper, silver, gold, mercury rhenium), nano-structured catalyst materials, nickel-iron compounds, or other catalyst materials or combinations of materials known for catalyzing desired reactions in an electrochemical cell. In some embodiments, a catalyst may comprise Raney Ni or NiCo2O4 spinel. In further examples, catalysts may include: (i) Precious metal-based catalysts including but not limited to: 20% Pt—Pd on Vulcan XC-72, 10% Pt on Vulcan XC-72, 20% Pt—Ru on Vulcan XC-72, 20% Pt—Ir on Vulcan XC-72, 20% Pt—Co on Vulcan XC-72, 20% Pt—Ni on Vulcan XC-72, IrO2, (ii) Perovskite catalysts including but not limited to: LaMnO₃, La_{0.8}Sr_{0.2}MnO₃, LaCoO₃ type perovskites, La_{0.7}Ca_{0.3}CoO₃, LaNiO₃ type perovskites; LaNi_{0.6}Fe_{0.4}O₃(B site substituted by Fe), Ba_{0.5}Sr_{0.5}Co_{0.2}Fe_{0.8}O₃, LaNi_{0.6}Fe_{0.4}O₃, (iii) spinel catalysts including but not limited to: NiCo₂O₄, Mn_{1.5}Co_{1.5}O₄, Co₃O₄, NiFe₂O₄, Co_{0.5}Ni_{0.5}Fe₂O₄.

In various embodiments, a catalyst may be applied to a porous gas layer, a substrate, a membrane, or other material (or combinations thereof) as a wet or dry mixture which may also include a binder. In various embodiments, a binder may be used to mechanically retain catalyst particles in the conductive layer 111 and/or to secure the conductive layer 111 to the porous gas layer 112 or other layers. Such a mixture is represented in the schematic illustration of FIG. 1(B) by layer 116 which is shown extending through a substrate material 121 and may contact the porous gas layer 112.

In some embodiments, a binder may comprise a fibrillatable polymer such as polytetrafluoroethylene (PTFE), a thermoplastic material such as polyvinylidene fluoride or polyvinylidene difluoride (PVDF), or a water-soluble polymer such as polyvinyl alcohol (PVA). In embodiments in which a fibrillatable polymer is used, a conductive layer 111 may be combined with a porous gas layer 112 under application of a shear force sufficient to fibrillate the fibrillatable polymer at the interface of the layers 111, 112, thereby mechanically bonding the layers with fibrillated fibers entangling structures in both layers. Such a layer of fibrillated bonding particles is schematically represented in FIG. 1(B) by layer 115.

Additional examples of electrodes of the second type are shown and described in PCT Application Publication No. WO2015/013764 and the PCT Patent Application filed contemporaneously with the present application entitled “Electrodes And Electrochemical Cells With Efficient Gas Handling Properties” and claiming priority to U.S. Provisional Patent Application Nos. 62/511,574 and 62/511,550, both filed on May 26, 2017. All of the patent applications described in this paragraph are incorporated herein by reference.

### Example 1: Fuel Cells for Extracting Energy from P2G Gas

Referring to FIG. 1(C), there is illustrated an example fuel cell 100 for generating electrical energy, or an electric potential, from a gas mixture. Fuel cell 100 comprises a first gas diffusion electrode 110 and a second gas diffusion electrode 120 in contact with and separated by a volume of electrolyte 130. Each of first electrode 110 and second electrode 120 comprises a gas-diffusion layer comprising a porous, liquid-impermeable material generally referred to herein as a porous gas layer (PGL).

In some examples, fuel cell 100 is an alkaline fuel cell utilizing the reactions (1) and (2):

H₂+2OH⁻→2H₂O+2e⁻ (eq. 1)

O₂+2H₂O+4e⁻→4OH⁻ (eq. 2)

In some examples, electrolyte 130 is an aqueous alkaline solution. In some examples, electrolyte 130 comprises KOH. In other examples, the electrolyte may be an acid electrolyte. The electrolyte may, alternatively, be a neutral electrolyte that is neither, or only partly acid or base.

As described above, in some embodiments, the porous gas layer may be made entirely or substantially of an expanded polytetrafluoroethylene (ePTFE) material. In some examples, each of first and second electrodes 110, 120 comprises a porous gas layer as a substrate which may directly or indirectly support a reaction catalyst. In other examples, the porous gas layer may be any other material that allows the flow of gas while preventing the flow of electrolyte 130.

In some examples, each of first and/or second electrodes 110, 120 may comprise a porous gas layer electrode coated or covered, at least in part, with a catalyst as described above. Normal operational use is, for example, when the electrode is functioning as intended and not flooded. At or near the surface of the porous gas layer is an interface or boundary region of the porous gas layer. When the electrode is in use, a three-phase solid-liquid-gas boundary, or interface, is able to form at or near the surface of the porous gas layer adjacent to or within the catalyst material or conductive layer. In use, each of first and second electrodes 110, 120 contacts the electrolyte 130 to form a solid-liquid interface. Therefore, during operation where gas inputs are supplied to first and second electrodes 110, 120, fuel cell 100 is a fuel cell having solid-liquid-gas interfaces between first and second electrodes 110, 120 (i.e. solid/gas) and electrolyte 130 (i.e. liquid).

In the example illustrated in FIG. 1(C), first electrode 110 may be an anode (i.e. the electrode at which an oxidation reaction occurs) and second electrode 120 may be a cathode (i.e. the electrode at which a reduction reaction occurs) of fuel cell 100. Fuel cell 100 is configured to supply a gas mixture 140 comprising hydrogen to the anode (i.e. first electrode 110). Fuel cell 100 is further configured to supply oxygen gas 150 to the cathode (i.e. second electrode 120).

Fuel cell 100 is provided with gas chambers 160 for the supply of gas mixture 140 and oxygen gas 150 to the anode and cathode, respectively, of fuel cell 100. In other examples, fuel cell 100 may comprise one or more gas chambers or tubes to supply relevant gases to the anode and cathode. In some examples, fuel cell 100 further comprises one or more mechanisms for controlling the rate of supply of gas mixture 140 and/or oxygen gas 150 to the anode and the cathode, respectively. Examples of such mechanisms include, but are not limited to, valves.

In some examples, gas mixture 140 comprises hydrogen gas and at least one other gas, such as methane, natural gas, or other hydrocarbon gas. In some examples, gas mixture 140 comprises hydrogen gas in a concentration of between about 5% and about 10%, by volume. In other examples, gas mixture 140 comprises hydrogen gas with a concentration lower than about 5%, by volume, but greater than 0%.

During operation, hydrogen gas contained within gas mixture 140 is supplied to the anode, seeping or permeating through its structure to reach the solid-liquid interface that the anode makes with electrolyte 130. At, or near, this interface, the hydrogen is oxidised. Simultaneously, oxygen gas 150 is supplied to the cathode, where it similarly travels to the solid-liquid interface that the cathode makes with electrolyte 130. At, or near, this interface, the oxygen is reduced. These two reactions create an electric potential difference between the anode and the cathode. If a load 170 is electrically connected between the anode and the cathode, electrons will flow through the load from the anode to the cathode, providing electrical energy to load 170.

In some examples, fuel cell 100, employing porous gas layer electrodes layered with suitable catalysts, and an alkaline electrolyte, is capable of operating sustainably when fuelled by mixtures of methane and hydrogen containing as little as 5% hydrogen. The porous gas layer substrate of the electrodes provides an active interface that allows the fuel cell to selectively extract the hydrogen from the methane and utilize it as a fuel. The performance of an example fuel cell with porous gas layer electrodes is characterised in the examples that follow over a wide range of hydrogen to methane ratios. At low levels of hydrogen, mass transport comprises the key limitation of the technology. This limitation can, however, be readily overcome by flowing the hydrogen-methane mixture through the cell at a sufficiently large rate. Tafel plot studies show that, in terms of its fundamental operation, there is, surprisingly, almost no difference between the use of a 5% hydrogen mixture and the use of 100% hydrogen, in the fuel cell.

In some examples, there is provided a method of generating electrical energy from a gas mixture comprising hydrogen gas. The method comprises the step of providing fuel cell 100 and supplying gas mixture 140 to first electrode 110. The method further comprises the step of supplying oxygen gas 150 to second electrode 120. In some examples, a rate of supply of gas mixture 140 to first electrode 110 increases as concentration of the hydrogen gas in gas mixture 140 decreases.

Example Fuel Cell with Porous Gas Layer Electrodes

An alkaline fuel cell containing two porous gas layer gas diffusion electrodes was constructed. In each of these, the porous gas layer substrate was coated with a catalyst layer containing 20% Pd—Pt/CB, dispersed PTFE as a binder, and a fine Ni mesh as a current carrier. Polypropylene-backed Preveil™ ePTFE (‘Gore-Tex’) membranes, produced by General Electric Energy were used in all experiments. These membranes are resistant to flooding at overpressures greater than 3 bar.

Expanded PTFE (ePTFE) was employed as a porous gas layer electrode substrate. ePTFE is also known by its trade name, Gore-Tex®. It comprises a hydrophobic, porous network of microscopically-small PTFE (also known as Teflon™) filaments. The key utility of ePTFE is that it combines high porosity with high hydrophobicity to thereby allow the passage of gases but not aqueous liquids. In relation to electrode substrates, ePTFE is advantageous because it has a significantly more uniform and hydrophobic pore structure than is possible in present-day, conventional gas diffusion electrodes. Nonetheless, other membrane materials having the same or similar properties may alternatively be used as a porous gas layer material.

International Patent Publication No. WO2015/013764 for a “Method and electrochemical cell for managing electrochemical reactions” filed on 30 Jul. 2014 describes that finely-pored ePTFE membranes may be used to fabricate gas diffusion electrodes that do not flood until the excess of the water-side pressure over the gas-side pressure is greater than 3 bar. This is more than an order of magnitude greater than conventional gas diffusion electrodes, which typically flood at overpressures lower than 0.1 bar. It drastically supersedes the cutting edge in conventional gas diffusion electrode technology, which involves flooding resistance up to 0.2 bar.

### Fuel Cell Operation Using Hydrogen-Methane Mixtures in the Range 5%-100%

Hydrogen gas or mixtures of hydrogen and methane gas at atmospheric pressure were allowed to slowly flow through the anode gas compartment of the test cell while oxygen gas at atmospheric pressure was slowly passed through the cathode gas compartment. Each of the gases employed were in high purity form. The liquid electrolyte was 6 M KOH. The cell was designed to ensure that each porous gas layer gas diffusion electrode had a 1 cm² geometric area. The anode and cathode electrodes were in a facing disposition to each other and separated by an inter-electrode gap of 3 mm. No diaphragm, ionomer, or other separator was present in the gap between the electrodes in the cell.

The performance of the above-described alkaline fuel cell was initially examined with mixtures of hydrogen and methane having varying concentrations of hydrogen: 50%, 40% 30%, 20%, 10% and 5%, by volume. The total flow of gas mixture in these experiments was kept constant at 20 ml/min. Detailed flow conditions are summarised in Table 1 below, which illustrates a table with the various parameters of the flow of H₂ and CH₄ in investigated mixtures, along with the measured open circuit voltage (Voc), electric potential upon application of 10 mA/cm² current density (E), highest power density (Pₘₐₓ), and ohmic resistance (R_{slop_unc}) from uncorrected polarization curves. Comparative experiments using pure hydrogen, were performed before and after the experiments with the hydrogen mixtures, in order to assess the stability of the system to methane gas.

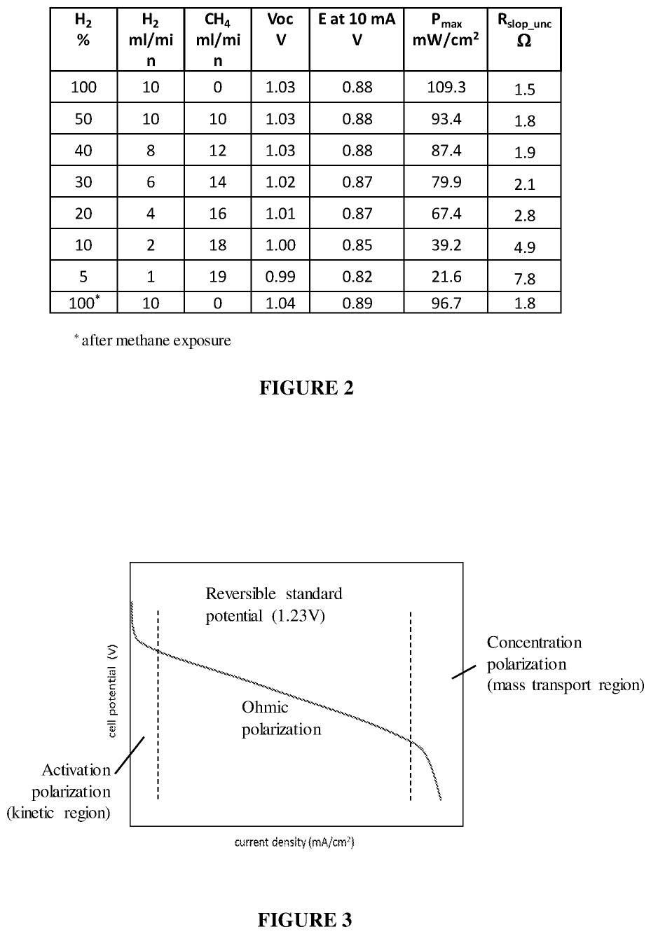

With reference to FIG. 2, a voltage drop of only 40 mV in the open circuit potential (Voc) was observed when cells supplied with pure hydrogen were compared with cells supplied with a methane blend containing 5% hydrogen. A 60 mV voltage drop was seen at a low current density of 10 mA/cm².

### Measured Polarization Curves

To characterize the overall fuel cell performance, polarization curves were measured. These curves plot voltage against current; an example of a typical polarization curve is provided in FIG. 3. Curves of this type have three different regions: (a) a kinetic, (b) an ohmic, and (c) a mass transport region. The kinetic region (non-linear voltage drop at the low current density), relates to the proportion of energy needed to start the chemical reactions on both electrodes. In this region, activation losses dominate the cell behaviour. In the ohmic region, kinetic, ohmic, and mass transport losses all participate, but ohmic losses dominate, and yield a linear polarization curve. Finally, in the mass transport region, losses derive from an insufficient supply of reactant/s, causing a significant nonlinearity.

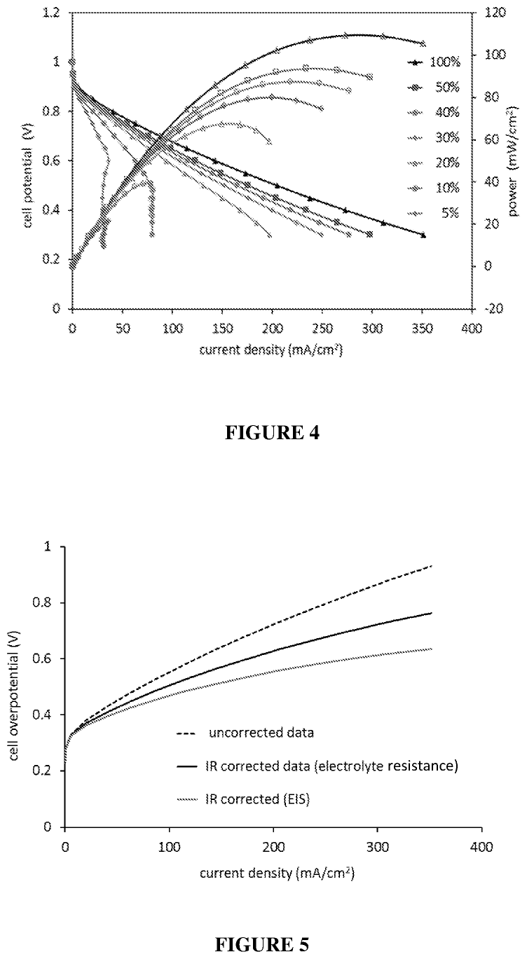

FIG. 4 illustrates the measured polarization curves (filled markers), and power curves (empty markers) of the example fuel cell for the different gas mixtures investigated. Cell potentials were measured between the cathode and anode, meaning that the polarization curves represent the combination of the polarizations of these two electrodes.

For the gas mixtures above, the linear part of the polarization curves illustrated in FIG. 4 demonstrated a gradual increase in slope magnitude with declining hydrogen proportions, from 1.5Ω for pure hydrogen to 7.8Ω for 5% H₂. This indicates a concomitantly increasing resistance according to Ohm's law (equation 3):

U=iR (eq. 3)

where i is the current flowing through the cell, and R is the total cell resistance, which includes electronic, ionic, and contact resistance. The estimated resistances from uncorrected polarization slopes for all gases are given in the table of FIG. 2.

The mass transport limitations in the polarization curves are clear for the 5% and 10% hydrogen mixtures, with the onset occurring earlier for the 5% mixture. When the cell voltage was 0.6 V, the hydrogen in the 5% mixture became almost depleted, which noticeably impaired the performance of the cells.

The losses due to hydrogen concentration occur over the entire range of current densities, but become more prominent at high currents densities, where the reaction rates are higher, causing faster consumption of reactants. A concentration gradient is formed if the mass transport is not fast enough to supply the reactant from the bulk of fluid into the electrode interface, which causes the potential loss. Several processes may contribute to this, such as slow diffusion in the gas phase into the electrode pores, solution/dissolution of reactants/products into/out of the electrolyte, or diffusion of reactants/products through the electrolyte to/from the electrochemical reaction site.

It can be seen that the percentage of hydrogen in the mixture had an impact on the maximum power density. With pure hydrogen, the highest power density was 109.3 mW/cm²; dilution of the hydrogen decreases the highest power density to 21.6 mW/cm² at 5% hydrogen in mixture (see FIG. 2).

To extract information about kinetic and mass transport losses and the ohmic resistance of the cell, the cell overpotential using pure hydrogen was plotted as a function of current density. The plot is illustrated in FIG. 5.

The Ohmic resistance of the supporting electrolyte (Eₑₗ) depends on the anode-to-cathode spacing or the charge-transport length (d), cross-sectional area of charge transport (A) and the ionic conductivity (σ) (eq. 4)

$${E}_{el} = \frac{d}{σ A} \qquad ( eq . 4 )$$

The Eₑₗ of the 6 M KOH electrolyte was calculated for 0.48Ω (d=0.3 cm, σ=0.63 S/cm, and A=1 cm²). Polarization curves were then IR-corrected by adding the current multiplied by the electrolyte resistance. FIG. 5 shows the uncorrected polarization curve for pure hydrogen (FIG. 5; dashed line) and the same curve corrected for the solution resistance (FIG. 5; solid, black line). The slope was still significant however.

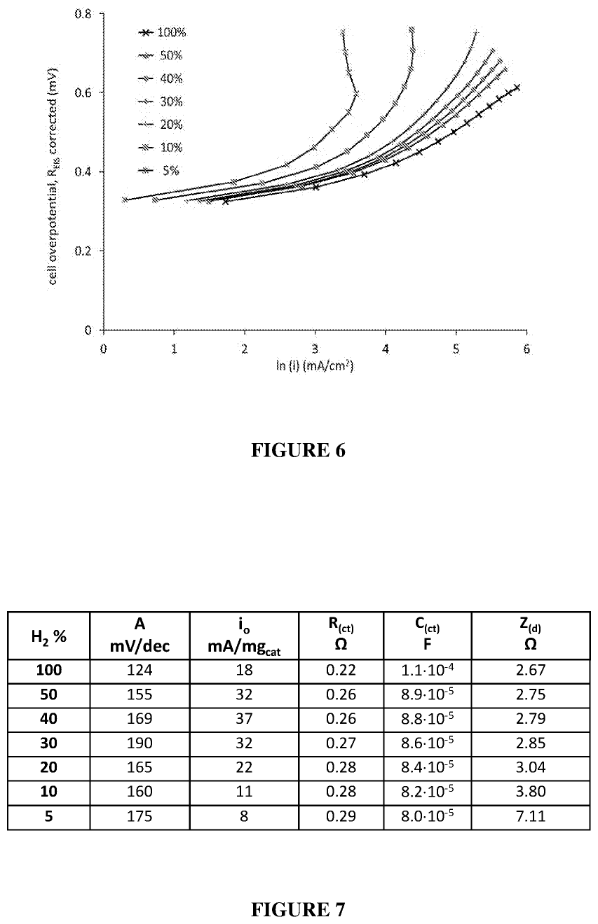

To better isolate the kinetic losses, the ohmic resistance (R₀=0.90±0.01) from electrochemical impedance spectroscopy (EIS) was applied to the correction in the same fashion (FIG. 5; solid, grey line). Impedance corrected polarization curves were later also used for the generation of Tafel plots (see FIG. 6).

### Tafel Plots

At low current densities, the kinetics are commonly modelled by the Tafel equation, given in eq. 5 below,

$$η = A ln ( \frac{i}{{i}_{o}} ) \qquad ( eq . 5 )$$

where η defines the overpotential, which is the difference between the electrode potential E and the standard potential E₀ (η=E−E₀), i denotes the current density, iₒ is the exchange current density, and A is the ‘Tafel slope’. The Tafel slope provides insight into the reaction kinetics and also the mechanism, to thereby elucidate the elementary steps and the rate determining steps. The Tafel slope A is higher for an electrochemical reaction that is slow, since a slow reaction leads to a higher overvoltage and the exchange current density iₒ can be considered as the current density at which the overvoltage begins to move from zero. If iₒ is high, then the surface of the electrode is more ‘active’ and a current in one particular direction is more likely to flow. It is desired to have as high a value of iₒ as possible, and as rapid kinetics as possible (low A).

FIG. 6 provides impedance-corrected Tafel plots for all investigated gas mixtures, having hydrogen concentrations varying from 5 to 100%. FIG. 7 illustrates a table that lists parameters obtained from the Tafel pots of FIG. 6. These parameters include the slope, A, (in units of mV/dec) and exchange current densities (iₒ) (in units of mA/mg_{cat}) calculated from the catalyst loading.

The estimated Tafel slope for pure hydrogen was 124 mV/dec. Tafel slopes of around 120 mV/dec and higher are frequently reported for both the hydrogen oxidation reaction (HOR) and the oxygen reduction reaction (ORR) in alkaline media, and on platinum-supported carbon (Pt/C) (See, for example: Genies, L.; Faure, R.; Durand, R. Electrochim. Acta 1998, 44, 1317; Shinagawa, T.; Garcia-Esparza, A. T.; Takanabe, K. Sci Rep 2015, 5, 13801). The slopes for all hydrogen-methane mixtures are higher in comparison to pure hydrogen and vary between 155-190 mV/dec, which suggest slower kinetics.

The exchange current densities iₒ estimated from the Tafel plots were higher for the mixtures with 20-50% hydrogen and lower for 10% and 5% compared to the iₒ of pure hydrogen (see FIG. 7). The reasons for this increase are not clear, however as noted by Almutairi and colleagues (in Almutairi, G.; Dhir, A.; Bujalski, W. Fuel Cells (Weinheim, Ger.) 2014, 14, 231), the Gibbs free energy (ΔG°) and standard equilibrium voltage (E°) in eq. 6, considered as the Voc, are higher for methane than for hydrogen.

This can explain the higher voltages observed with the addition of methane into hydrogen.

$${E}^{o} = - \frac{Δ {G}^{o}}{zF} \qquad ( eq . 6 )$$

(Methane: ΔG°=−818 Kj/mol, E°=1.41 V versus hydrogen: ΔG°=−237 kJ/mol, E°=1.23 V, z is the molar number of electrons being transferred, and F is Faraday's constant).

The lower iₒ for the 5-10% gas mixtures can possibly be explained by the reduced access of hydrogen to the so-called solid-liquid-gas interface in the electrode, while competing with the methane flow. However, as can be seen in FIG. 6, the Tafel plots are strongly influenced by concentration losses in these diluted mixtures, and as recognised by Shinagawa et al (Shinagawa, T.; Garcia-Esparza, A. T.; Takanabe, K. Sci Rep 2015, 5, 13801), the contribution of mass-transport can lead to misinterpretation of the kinetics due to inaccurate Tafel slopes.

Perhaps the key insight that can be derived from the iₒ and A values in the table of FIG. 7 is the fact that, despite the differences, they are all of similar order of magnitude. This is, in fact, rather stunning given the enormous differences in the proportion of hydrogen present in the mixtures fed into the cells. It indicates that all of the fuel cells considered in FIG. 7 (5%-100% hydrogen) operate in a very similar way. That is, while the kinetics may slow somewhat at high dilutions of hydrogen in the reactant gas mixture, the operation of the fuel cell is, in essence, the same.

### Electrochemical Impedance Spectroscopy

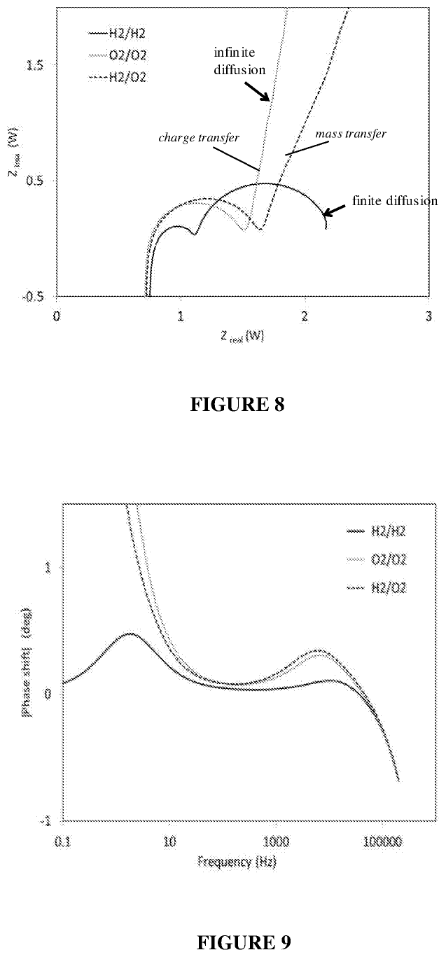

To break down the total cell resistance into individual polarization contributions, electrochemical impedance spectroscopy (EIS) was applied. EIS has proved to be very useful in distinguishing processes with different time constants. The preliminary EIS measurements were taken with symmetrically supplied hydrogen (H₂/H₂) and oxygen (O₂/O₂) at the two electrodes of the cell, to determine the anode and cathode transfer functions at the open circuit potential (Voc) and compare this with cells operated with either H₂ or O₂ at the same conditions (see: Wagner, N.; Schnurnberger, W.; Muller, B.; Lang, M. Electrochim. Acta 1998, 43, 3785). FIGS. 8 to 11 are relevant to these measurements.

In the Nyquist diagram illustrated in FIG. 8, the higher frequency arc (charge transfer) reflects the combination of effective charge-transfer resistances (R_{ct}) associated with the processes at the electrodes and a double-layer capacitance within the catalyst layer (C_{ct}), with the low-frequency part of the spectrum (mass transfer) representing the mass-transport limitations.

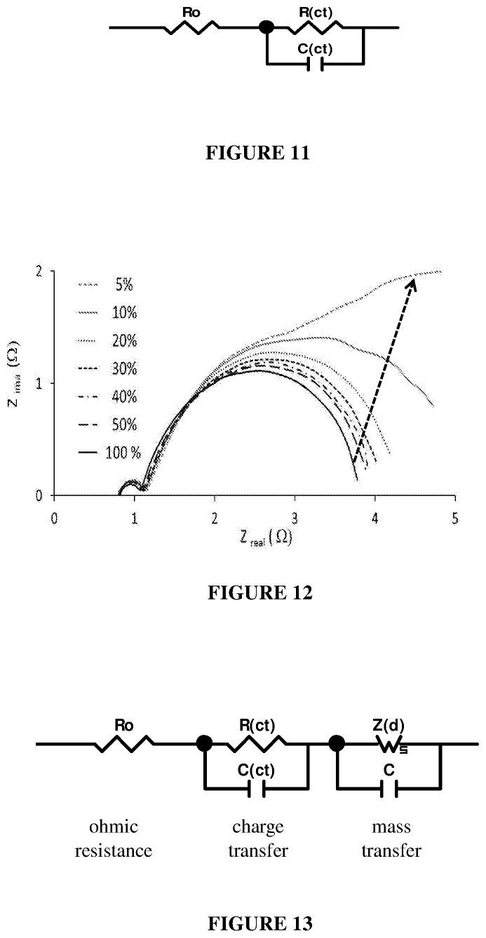

The impedance spectra in the higher frequency range were simulated with the equivalent circuit illustrated in FIG. 11 and the inductance of the wires was not considered. Ro in the equivalent circuit of FIG. 11 represents ohmic resistance.

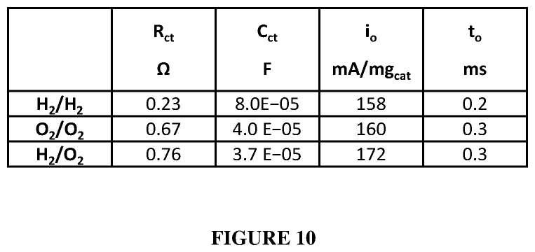

FIG. 10 illustrates a table listing charge transfer resistance (R_{ct}), double layer capacitance (C_{ct}), exchange current density (iₒ) and relaxation time tₒ for an example fuel cell. The exchange current density and relaxation time were calculated from values of R_{ct} and C_{ct} obtained after fitting the data to equivalent circuit of FIG. 11.

The charge transfer arc for H₂/H₂ shows lower R_{ct} and higher C_{ct} when compared to cells operated with O₂/O₂ and H₂/O₂. Additionally, from the Bode plot illustrated in FIG. 9, which provides a clearer description of the electrochemical processes in the frequency domain, it is visible that charge transfer for the H₂/H₂ cell occurs at a higher frequency (=16 kHz) compared to O₂/O₂ and H₂/O₂ (=10 kHz). The relaxation time tₒ (eq. 7), which is related to the recovery rate of the steady-state when a perturbation is applied to the system, is then shorter for H₂/H₂ then for O₂/O₂ and H₂/O₂ which again indicates faster kinetics.

$${t}_{o} \approx \frac{1}{{ω}_{min}} = \frac{1}{2 π f} = RC \qquad ( eq . 7 )$$

where ωₘᵢₙ is the frequency at which the phase shift is minimum.

However, the exchange current density iₒ, calculated from the charge transfer resistance R_{ct} at open cell voltage (eq. 8), was equal for the anode and cathode: i_{o anode}=0.16 A/mg_{cat} and i_{o cathode}=0.16 A/mg_{cat}.

$${R}_{ct} = \frac{RT}{{zFi}_{0}} \qquad ( eq . 8 )$$

where z is the number of electrons involved in overall reaction, R the gas constant, T the temperature and F the Faraday constant.

Sheng et al reported somewhat higher numbers, that were, nevertheless, close for HOR/HER and ORR in 0.1 M KOH and on Pt carbon support (i_{o anode}=0.35 A/mgₚₜ and i_{o cathode}=0.26 A/mgₚₜ) (see: Sheng, W.; Gasteiger, H. A.; Shao-Horn, Y. Journal of The Electrochemical Society 2010, 157, B1529).

Thus, it can be concluded that the charge transfer resistances of both electrodes significantly contribute to the impedance of a fuel cell (H₂/O₂) at open circuit potential (Voc). One can also see in the H₂/H₂ case, finite diffusion as an additional loop at the lowest part of the frequency range and infinite diffusion as a straight line with slopes close to 1 in the O₂/O₂ and H₂/O₂ spectra (see FIG. 8).

To investigate the EIS of the gas mixtures, spectra were collected at a constant current density of 10 mA/cm² (close to the Voc, see FIG. 2) for: 100%, 50%, 40% 30%, 20%, 10% and 5% hydrogen concentrations in methane mixtures. The total gas flow was kept constant at 20 ml/min. The results are depicted as Nyquist plots in FIG. 12. Two arcs are visible for the cell operating with pure hydrogen, which corresponds to two relaxation times; namely, the smaller, charge transfer arc at high frequencies (40 kHz-200 Hz,) and a larger, mass transfer arc at lower frequencies (200 Hz-0.1 Hz) which describe finite diffusion, also known as the Nernst impedance. To estimate all resistances of the cell from the EIS measurements, the data were fitted to a transmission line model illustrated in FIG. 13 with the results given in the table of FIG. 7.

In general, the intercept of the arc with the real axis at the high-frequency end represents the total ohmic resistance (or electrolyte resistance, often used in fuel cell literature), R₀. The ohmic resistance is recognized as the sum of the contributions from uncompensated contact resistance and the ohmic resistance of cell components such as electrolyte (electrolyte ionic resistivity) and electrodes.

For all measured mixtures including pure hydrogen, R₀=0.90±0.01Ω remained constant. The charge transfer arc varied only slightly with a decrease in the hydrogen proportion within the gas mixture. Thus, the charge transfer resistance changed only from 0.22 Ωcm² when using pure hydrogen to 0.29 cm² when the hydrogen was diluted to 5% using methane. This equates to an ≈30% increase in the key resistance feature of the cell that essentially determines its overall efficiency. The gortex-based alkaline fuel cell was clearly highly efficient.

The mass transfer arc of the gortex-based alkaline fuel cell significantly expanded as the H₂ proportion decreased. Increased resistances estimated from this arc indicate longer relaxation times with hydrogen dilution, which correspond to a lower freedom of transport within the cell. The mass transfer arc was readily eliminated and the associated mass transfer resistance reduced to zero by simply increasing the overall flow of H/inert gas through the anode without changing the diluent proportion.

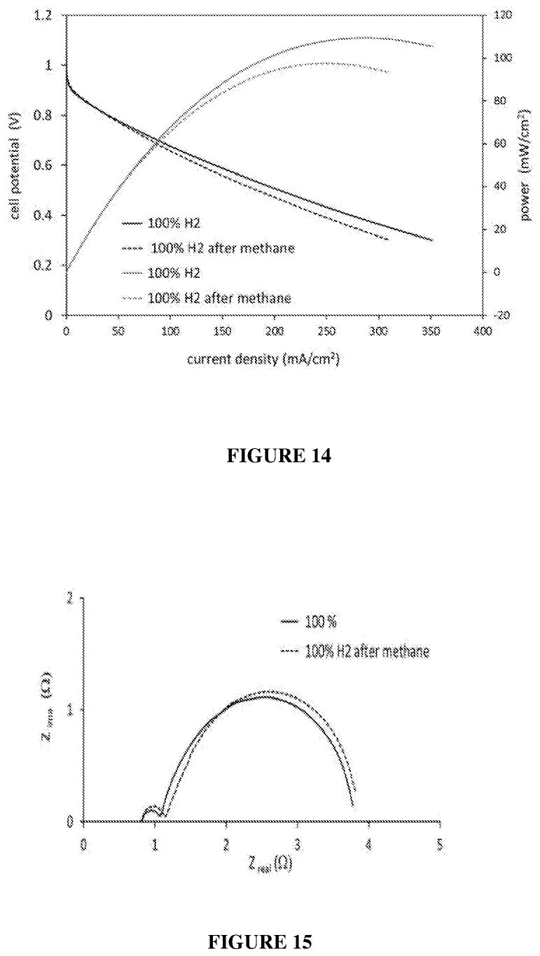

After completion of all of the above measurements with the hydrogen-methane mixtures, the cells were again fed with pure hydrogen and polarization (j-V) curves and EIS measurements, illustrated in FIGS. 14 and 15, respectively, were compared with the first results obtained with pure hydrogen from FIG. 2.

Referring to FIG. 14, the (j-V) results show, that after the cells were exposed to methane, there was a slight increase in the overvoltage at higher current density. Thus, 40 mA/cm² less current was generated at a cell voltage of 0.3 V. The highest power density of 109.3 Mw/cm² (FIG. 3) also decreased to 96.7.6 Mw/cm² (FIG. 14). This may be a result of the reaction being “starved” while collecting the data for 5% and 10%, at a higher current density range. However, both (j-V) and (j-P) curves in the range up to 50 mA/cm² did not change (FIG. 14), indicating that the system was, effectively, fully reversible in this range. That is, it essentially recovered its full performance after being treated with the hydrogen-methane mixtures.

Referring to FIG. 15, full reversibility of the cell in the low current density range was also confirmed with EIS performed at 10 mA/cm², and the cell demonstrated a fully recovered performance (stable potential of 0.89V at 10 mA/cm², see FIG. 2).

### Hydrogen-Methane Mixtures in the Range 2%-5%

To further probe lower concentrations of hydrogen, below 5%, a further set of experiments was performed with a fixed flow rate of hydrogen/methane of 1 ml/min. In these experiments the cell potential was limited to 0.6 V to avoid cell starvation.

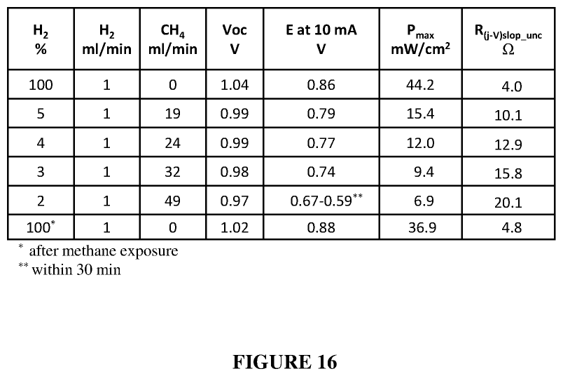

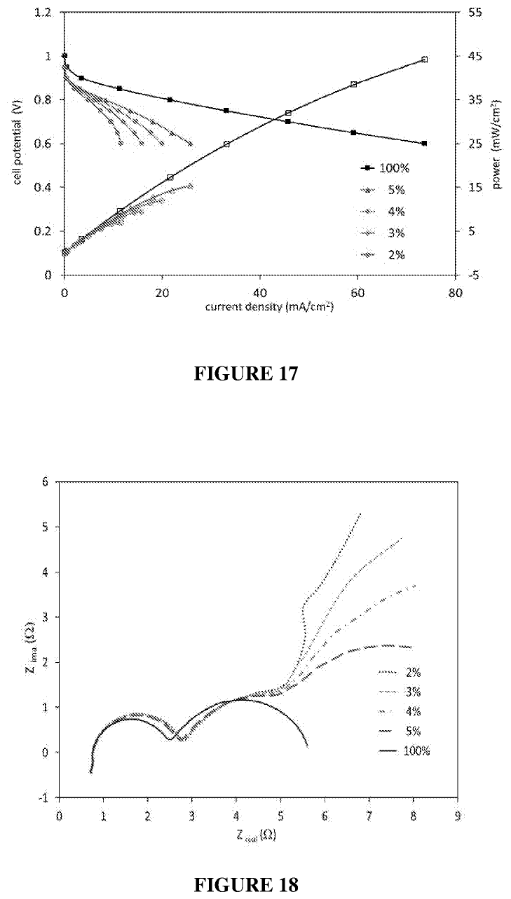

Referring to FIG. 16, there is illustrated a table listing parameters of the flow of H₂ and CH₄ in investigated mixtures, along with the measured open circuit voltage (Voc), electric potential upon application of 10 mA/cm² current density (E), highest power density (Pₘₐₓ) and ohmic resistance (R_{slop_unc}) from uncorrected polarization curves. FIGS. 17 and 18 measured polarisation and EIS curves for the example fuel cell.

As with the previous set of results, referring to FIGS. 16 and 17, the slopes of the polarization curves (j-V) and (j-P) were found to gradually change with hydrogen dilution, indicating a further increase in the cell resistances. The potentials monitored at the cell with an applied current density of 10 mA/cm² were lower by 70 mV (5%), 90 mV (4%), and 120 mV (3%). All of these were stable. The mixture having 2% hydrogen however (see table in FIG. 16), originally exhibited a voltage of 0.67 V but after 30 min this gradually changed to 0.59 V, which indicates that it was at the border of stability. Galvanostatic EIS measurements at 10 mA/cm², illustrated in FIG. 18, also showed an increase of resistance deriving from mass transport.

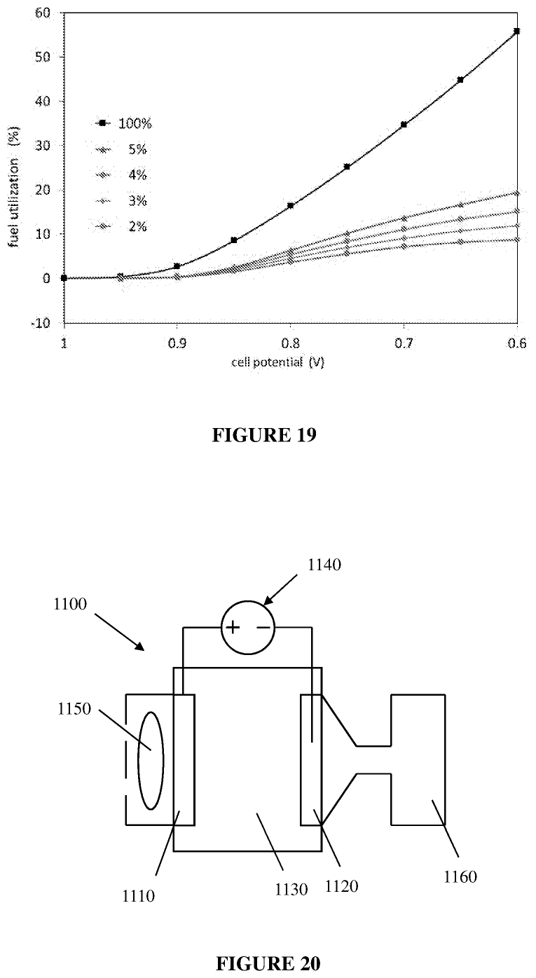

The extent of fuel utilization (FU) was calculate from eq. 9 and plotted in FIG. 19; in all cases the cell was fed with the same amount of hydrogen or hydrogen/methane of 1 ml/min.

$$FU = \frac{{H}_{c}}{{H}_{f}} \times 100 [ \% ] \qquad ( eq . 9 )$$

where H_{c} is the theoretically produced hydrogen on the basis of the current intensity and H_{f} is hydrogen fed to the cell. At the low current density of 10 mA/cm² (0.8 V) the fuel utilization was FU_{100% H2,0.8V}=16% for the pure hydrogen and FU_{5% H2,0.8V}=6% for the 5% mixture.

For the highest current density and the applied potential of 0.6 V, the difference increases, as does the increased mass transport resistances. For pure hydrogen FU_{100% H2,0.6V}=56% and for 5% mixture only FU_{5% H2,0.6V}=19%. With the further dilution of hydrogen below 5%, the values of FU decrease further.

These results imply that with a more dilute mixture, more hydrogen is wasted. Lower currents generated by the cell with the same amount of fed hydrogen suggest again, that the hydrogen access to the catalyst surface is reduced. However, when compared to pure hydrogen, this drop of FU does not follow the percentage of dilution. One of the reasons could be the difference in kinetic diameters, which is quite often invoked in discussing gas permeation in porous materials; these are smaller for hydrogen when compared to methane (2.9 Å vs 3.8 Å) (see: Mehio, N.; Dai, S.; Jiang, D.-e. J. Phys. Chem. A 2014, 118, 1150).

### Water Balance in the Fuel Cell

While studies did not examine the issue of water balance, it should be noted that water is produced in the gortex-based fuel cell. Its potential accumulation within the aqueous 6 m KOH electrolyte would therefore need to be considered. The electrolyte is also in direct contact (through the gortex interface) with the flowing gases, meaning that a humidification equilibrium would be created in the gas chambers. This equilibrium would depend on the operating temperature of the fuel cell and the excess heat it generates. In the process, water vapor from the electrolyte would be taken up by the gases, potentially depleting the water content of the 6 m KOH electrolyte. In a cell fuelled by hydrogen-enriched natural gas, the competing processes of water accumulation and water depletion would ideally be balanced. The outlet gas from the anode would then contain water vapor and would have to be dehumidified prior to re-entering the natural gas pipeline. In a perfectly balanced system however, the dehumidification step would, effectively, be removing the excess water created during the cell reaction.

### Summary: Fuel Cell

An alkaline fuel cell has been described employing porous gas layer electrodes layered with suitable catalysts, that is capable of operating sustainably when fuelled by mixtures of methane and hydrogen containing as little as 5% hydrogen. The porous gas layer substrate of the electrodes provided a remarkably active interface that allowed the fuel cell to selectively extract the hydrogen from the methane and utilize it as a fuel. The performance of the fuel cell has been examined over a wide range of hydrogen to methane ratios. At low levels of hydrogen, mass transport comprises the key limitation of the technology. This limitation can, however, be readily overcome by flowing the hydrogen-methane mixture through the cell at a sufficiently large rate. Tafel plot studies showed that, in terms of the fundamental operation, there is, astonishingly, almost no difference between the use of a 5% hydrogen mixture and the use of 100% hydrogen. To the best of the inventors' knowledge, only solid oxide fuel cells operating at temperatures greater than 700° C. are presently capable of extracting electricity from natural gas pipelines at desktop scale. The present technology provides a potentially useful future alternative.

The examples above have investigated some of the properties of an example alkaline fuel cell having porous gas layer gas diffusion electrodes for power generation from dilute mixtures of hydrogen and methane. These properties can be summarised as follows:
1. Hydrogen dilution: At a low current density of 10 mA/cm², the studied class of AFC can operate efficiently with dilution of hydrogen down to 5% and with an overvoltage of only 60-70 mV above the potential required when the cell is fed with pure hydrogen. Indeed, Tafel plot studies show that, in terms of the fundamental operation, there is essentially no difference between a 5% hydrogen mixture and 100% hydrogen. In particular, the key measure of charge transfer resistance, which sets the overall efficiency of the cell, displays only an ≈30% increase in going from pure hydrogen as a fuel, to 5% hydrogen. This seems to be an extraordinary result.
2. Cell losses: Mass transport losses, which are dominant in the example system investigated, start to appear at low current densities, when the hydrogen concentration goes below 20%. But the increased resistance provided by the mass transport limitations are only mild down to about 5% mixtures of hydrogen. Moreover, they can, effectively, be circumvented by simply increasing the overall flow rate of the dilute hydrogen-methane mix through the cell. The cell can operate successfully under this condition. The limitation at higher current densities involves depletion of the hydrogen from the mixture. For 5% hydrogen and a flow of 1 ml/min, at potentials exceeding about 0.6 V, the cell reaction begins to starve, with the highest power density achieved for this mixture is 21.6 mW/cm².
3. Reversibility: The cells were fully reversible after exposure to methane, which indicates that the methane gas has an inert behaviour in the cell and that no catalyst deactivation occurs.
4. Porous gas layer electrodes: The novel porous gas layer (e.g., “Gore-Tex” or other ePTFE material) substrates of the electrodes and the aqueous alkaline electrolyte clearly provide a remarkably active solid-liquid interface and ion conductor that allows the fuel cell to selectively extract the hydrogen from the methane and efficiently utilize it as a fuel. These solid-liquid elements are clearly significantly more efficient than conventionally available technologies.
5. Ability to extract electricity from methane enriched with hydrogen: To the best of the inventors' knowledge, only solid oxide fuel cells operating at temperatures greater than 800° C. are presently capable of extracting electricity from natural gas pipelines at desktop scale. As natural gas is mostly methane, the present cell offers a potential means of generating electrical power locally by utilizing the dilute 5-10% hydrogen-methane mixtures envisaged for power-to-gas technologies.

### Example 2: Gas Extraction Cell for P2G Gas

Referring to FIG. 20, there is provided an example electrochemical cell 1100 for extracting, or separating, hydrogen gas from a gas mixture. Electrochemical cell 1100 comprises a first gas diffusion electrode 1110 and a second gas diffusion electrode 1120. Electrochemical cell 1100 further comprises a liquid electrolyte 1130 in contact with both first electrode 1110 and second electrode 1120. Each of first electrode 1110 and second electrode 1120 may comprise any of the porous gas layer electrode structures described herein above.

Each of first and second electrodes 1110, 1120 contacts electrolyte 1130 to form a solid-liquid interface. Therefore, electrochemical cell 1100 is a liquid-acid electrochemical cell having solid-liquid interfaces between first and second electrodes 1110, 1120 (i.e. solid) and electrolyte 1130 (i.e. liquid).

Electrochemical cell 1100 further comprises an electrical power source 1140 electrically connected to first electrode 1110 and second electrode 1120. The polarity of power source 1140 is such that, in this particular example, first electrode 1110 is an anode while second electrode 1120 is a cathode of electrochemical cell 1100. Power source 1140 may comprise one or more batteries, electricity generators, or any other source of electrical energy.

Preferably, though not necessarily, electrolyte 1130 is a proton-diffusing liquid, i.e. a liquid through which protons can diffuse, flow, or propagate. In some examples, electrolyte 1130 is electrically conductive. In some examples, electrolyte 1130 comprises an acid, or a strong acid. An example of an acid for electrolyte 1130 is H₂SO₄. In some examples, electrolyte 1130 comprises an acid in an aqueous solution.

In some examples, there is not any ion-permeable diaphragm or ionomer positioned between first and second electrodes 1110, 1120. In some examples, in order to accommodate electrolyte 1130, the electrolyte chamber between first and second electrodes 1110, 1120 may be undivided in any way. That is, an ion-permeable, liquid-impermeable and/or gas-impermeable diaphragm or ionomer may not be positioned or arrayed between the electrodes, so as to thereby ensure that liquid electrolyte about the anode(s) are in free and unhindered fluid flow and fluid communication with the liquid electrolyte or the gel electrolyte about the cathode(s).

Electrochemical cell 1100 is configured to supply a gas mixture 1150 to the anode. In some examples, electrochemical cell 1100 may comprise one or more gas chambers or tubes adjacent to a porous gas layer of the anode (positive) electrode 1110 for supplying a gas mixture 1150 to the anode. In some examples, electrochemical cell 1100 further comprises a mechanism for controlling the rate of supply of gas mixture 1150 to the anode. Examples of such mechanisms may comprise valves or flow regulators.

During operation of electrochemical cell 1100, gas mixture 1150 comprising hydrogen gas is introduced into the ePTFE substrate of the anode (i.e. first electrode 1110). The hydrogen gas within gas mixture 1150 is oxidised once it reaches the solid-liquid interface between the anode and electrolyte 1130. This oxidation reaction produces protons (i.e. hydrogen ions) that are transported, or diffuse, to the cathode (i.e. second electrode 1120) through electrolyte 1130. At the cathode, the protons undergo a reduction reaction and form pure hydrogen gas which may pass through the porous gas layer of the cathode into a gas chamber or other gas conduit adjacent to the cathode (negative) electrode 1120. Therefore, electrolyte 1130 forms or provides a channel, or medium, for transferring or conducting protons from the anode to the cathode.

In summary, during operation of electrochemical cell 1100, gas mixture 1150 is supplied to first electrode 1110 and, upon an electric potential difference (or voltage) being supplied, or provided from a source external to electrochemical cell 1100, between first and second electrodes 1110, 1120, hydrogen gas is outputted from second electrode 1120. The polarity of the electric potential difference should be such that a first electric potential energy at the electrode where gas mixture 1150 is supplied (i.e. the anode) is higher than second electric potential energy at the electrode from which hydrogen gas is outputted (i.e. the cathode). Therefore, first electrode 1110 is the “positive” electrode and second electrode 1120 is the “negative” electrode, such that protons flow from first electrode 1110 to second electrode 1120 through electrolyte 1130.

Gas present within gas mixture 1150 that is not hydrogen gas (for example, methane gas), together with any excess, or remaining, unreacted hydrogen gas, inertly pass through the anode and leave electrochemical cell 1100.

In some examples, electrochemical cell 1100 is configured to collect a gas product from the cathode. The gas product is a product of electrochemical reactions occurring within electrochemical cell 1100 during operation. In this specific example, the gas product is hydrogen gas. In some examples, electrochemical cell 1100 may comprise a gas chamber for storing the gas product.

The hydrogen gas formed at the cathode seeps through, or is absorbed by, the cathode, where it is collected within or transferred to a gas chamber or container 1160. In the specific example illustrated in FIG. 20, gas chamber 1160 is external to, and separate from, second electrode 120. In some examples, gas chamber 1160 is connected, through a gas flow medium, such as a tube or a gas permeable material, to the cathode. In other examples, gas chamber 1160 may be provided internally and as part of the cathode. That is, the cathode electrode comprises a gas chamber for collecting and/or storing hydrogen gas formed at the cathode.

In some examples, gas chamber 1160 has a fixed volume such that, while hydrogen gas is being generated at the cathode and collected within gas chamber 1160, the hydrogen gas within gas chamber 1160 is compressed. In other examples, hydrogen gas formed at the cathode is not stored and is transferred to an external gas distribution system or to an appliance for use.

Electrochemical cell 1100 enables electrochemical extraction, recovery, and purification of hydrogen from a gas mixture with high efficiency. Extraction occurs in a single step (i.e. in a single electrochemical cell), even for exceedingly dilute mixtures of hydrogen where, for example, the initial gas mixture comprises a concentration of hydrogen gas of about 5%, by volume. In other examples, a battery, or electrochemical cell array, may comprise two or more interconnected electrochemical cells 1100 to provide a multi-stage, or multi-step, hydrogen extraction or purification process.

The efficiency of the electrochemical cell is due to a number of factors. Firstly, the solid/liquid interface between the solid electrodes and the liquid electrolyte increases the efficiency of the electrochemical reactions (i.e. oxidation and reduction) relative to comparable solid/solid interfaces in conventional technologies. Secondly, the acidic electrolyte is significantly more conductive than alternative proton conductive membranes or electrolytes. At low levels of hydrogen in the feedstock gas, mass transport may comprise the key limitation of the technology. This limitation can, however, be readily overcome by flowing the feedstock gas, for example a hydrogen-methane mixture, through the cell at a sufficiently high rate.

Alternatively, this gas transport limitation may be overcome by using feedstock gas at a higher pressure than atmospheric (within a cell that is also pressurised to, or above the pressure of the feedstock gas). For example, the feedstock gas may be supplied at a pressure of 14 bar, 30 bar, or 100 bar. Natural gas pipelines have typical pressures of anywhere from 14.2 bar to 107.2 bar.

In some examples, first and second electrodes 1110, 1120 have symmetrical structures, compositions, and/or geometries. In other examples, first and second electrodes 1110, 1120 are not symmetrical. For example, in various embodiments, the first electrode 111 may have a different catalyst, a different catalyst loading, a different surface area, a different porosity, a different bulk volume, or other different properties as compared with the second electrode 1120.

In some examples, gas mixture 1150 comprises hydrogen gas and at least one other gas such as methane, natural gas, or other hydrocarbon gas mixtures, or other gas mixtures. In some examples, gas mixture 1150 comprises hydrogen gas in a concentration of between about 5% and about 10%, by volume. In other embodiments, gas mixture 1150 may comprise a hydrogen gas concentration less than about 5%.

In some examples, a method of extracting hydrogen gas from a gas mixture, comprises the steps of providing electrochemical cell 1100 and supplying an electric potential difference between first and second electrodes 1110, 1120, wherein first electrode 110 is an anode, and wherein second electrode 1120 is a cathode. The method further comprises the steps of supplying gas mixture 1150 to first electrode 1110 (i.e. the anode) and collecting a gas product from second electrode 1120, wherein the gas product is a product of electrochemical reactions occurring within electrochemical cell 1100.

In some examples, the method further comprises the step of storing the gas product in a gas chamber having a fixed volume to compress the gas product. In some examples, the gas product is hydrogen gas.

The origin of the efficiency of the electrochemical cell appears to fundamentally derive from the solid-liquid interface between the (solid) porous gas layer electrodes and the (liquid) electrolyte, and the proton conductivity of the liquid electrolyte. This interface and electrolyte exhibit an efficiency for selective extraction of hydrogen from gas blends, conversion of the hydrogen into protons, and transport of those protons in the proton conducting liquid phase between the electrodes, that greatly exceeds that achieved by conventional technologies.

Example Electrochemical Cell with Porous Gas Layer Electrodes

A liquid acid cell containing two porous gas layer gas diffusion electrodes was constructed. In each of these, the porous gas layer substrate was coated with a catalyst layer containing 10% Pt/CB, dispersed PTFE as a binder, and a fine Ni mesh as a current carrier. Polypropylene-backed Preveil™ ePTFE membranes, produced by General Electric Energy were used in all experiments. These membranes are resistant to flooding at overpressures greater than 3 bar. The Pt loading was 0.05 mg cm⁻², which is unusually low when compared to conventional systems.

In these examples, expanded PTFE (ePTFE), was employed as an electrode substrate. It comprises a hydrophobic, porous network of microscopically-small PTFE (also known as Teflon™) filaments. The key utility of ePTFE is that it combines high porosity with high hydrophobicity to thereby allow the passage of gases but not aqueous liquids. In relation to electrode substrates, ePTFE is advantageous because it has a significantly more uniform and hydrophobic pore structure than other present-day, conventional gas diffusion electrodes.

International Patent Publication No. WO2015/013764 for a “Method and electrochemical cell for managing electrochemical reactions” filed on 30 Jul. 2014 teaches that finely-pored ePTFE membranes may be used to fabricate gas diffusion electrodes that do not flood until the excess of the water-side pressure over the gas-side pressure is greater than 3 bar. This is more than an order of magnitude greater than conventional gas diffusion electrodes, which typically flood at overpressures of less than 0.1 bar. It drastically supersedes the cutting edge in conventional gas diffusion electrode technology, which involves flooding resistance up to 0.2 bar.

The cell's operation was characterised through various measurements, including electrochemical impedance spectroscopy.

### Initial Electrochemical Cell Characterization

During the initial examinations, mixtures of hydrogen and methane at atmospheric pressure were allowed to slowly flow through the anode gas compartment of the test cell. Each of the gases employed were supplied, in high purity form, from attached cylinders. Pure hydrogen was collected at the cathode. The cell was designed to ensure that each porous gas layer gas diffusion electrode had a 1 cm² geometric area. The anode and cathode electrodes were placed in a facing disposition to each other with respective conductive catalyst regions facing one another and respective porous gas layers facing away from one another. The electrodes were separated by an inter-electrode gap of 3 mm that was filled with liquid electrolyte containing a strong acid (1 M H₂SO₄). No diaphragm or ionomer barrier was present in the gap between the electrodes in the cell.

In general, only a small amount of external power is required to carry out the hydrogen oxidation reaction (HOR, eq.1) at one electrode in an electrochemical cell and the hydrogen evolution reaction (HER, eq.2) at the other. This arises because only a low polarization of the electrodes, with an accompanying low theoretical voltage, is needed to transport protons through the electrolyte between the electrodes.

HOR Anode H_{2(gas)}→2H⁺+2e⁻ (eq.1)

HER Cathode 2H⁺+2e⁻→H_{2(gas)} (eq.2)

The minimum potential necessary can be calculated from the Nernst equation (eq. 3):

$$E = {E}_{0} - 2.3 \frac{RT}{n F} log \frac{p 1}{p 2} \qquad ( eq . 3 )$$

where: E is the potential necessary for hydrogen ions (protons) to be transported from the positive electrode (anode) to the negative electrode (cathode), E₀ is the standard cell potential which is 0 V relative to the normal hydrogen electrode (NHE) for hydrogen, R is the gas constant, T is the temperature, n is the numbers of electrons involved in the electrode process, F is the Faraday constant, p₁ is the partial pressure of the hydrogen gas at the positive electrode, and p₂ is the partial pressure of the hydrogen gas at the negative electrode.

For a mixture of 5% hydrogen (0.05) in methane introduced into a cell of the above-described type at 25° C., a voltage of only 0.076 V is theoretically required to drive the protons from the anode to the cathode (eq. 4):

$$E = 0 - 2.3 \frac{8.31 * 295}{96487} log \frac{0.05}{1} = + 0.076 [ V ] \qquad ( eq . 4 )$$

The calculated voltage of 76 mV is minimal but in practice, because of the resistance of the electrolyte in the cell, an additional voltage must be provided. The conductivity of 1 M sulfuric acid in 25° C. is reported in the scientific literature to be 0.35 S/cm, and 0.83 S/cm for 4.5 M sulfuric acid (H₂SO₄) (see: Darling, H. E. J. Chem. Eng. Data 1964, 9, 421). In the latter case, however, such high H₂SO₄ concentration can lead to an increase in sulfate/bisulfate adsorption on, especially, Pt catalyst surfaces, thereby blocking catalytic sites (see: Gamoa-Aldeco, M. E.; Herrero, E.; Zelenay, P. S.; Wieckowski, A. J. Electroanal. Chem. 1993, 348, 451). For this reason, it was decided to demonstrate the cell using 1 M H₂SO₄ as electrolyte.

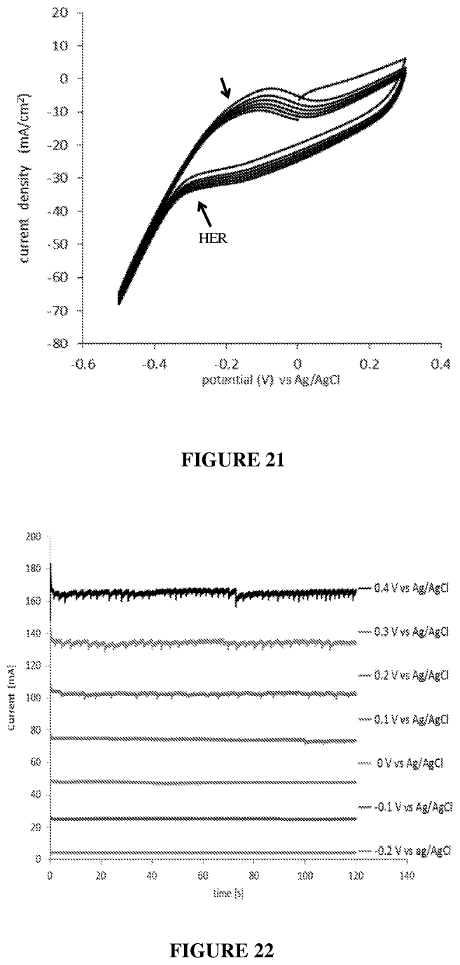

The HOR and HER for the catalyst used in this example (0.5 g·m⁻² Pt on Vulcan carbon black, at both the anode and the cathode) were determined in 1 M H₂SO₄ for the example cell configuration. FIG. 21 illustrates example cyclic voltammetry measurements. To determine the actual potential, the reactions were monitored against a Ag/AgCl reference electrode placed in the top of the cell. The HOR trace is visible on the anodic scan at the broad peak at −0.23 V vs. Ag/AgCl (−0.02 V vs. NHE). With reference to FIG. 21, the onset of hydrogen evolution can be seen to start from −0.33 V vs. Ag/AgCl (−0.12 vs. NHE).

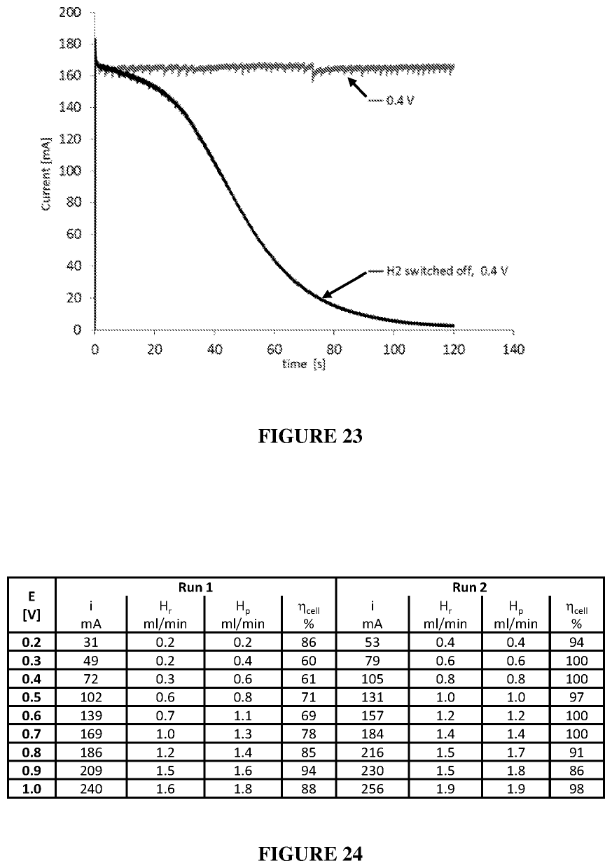

The performance of the cell was then determined under potentiostatic conditions, measuring the current at applied potentials from −0.2 V to 0.4 V, vs. Ag/AgCl, as illustrated in FIG. 22. Pure hydrogen with a flow of 10 ml/min, was supplied to the anode compartment. The first gas generated at the cathode was observed at a potential of −0.1 V, which is about 100 mV above the oxidation potential of hydrogen in this cell. Control measurements were performed by switching off the hydrogen flow to the anode at all potentials (depicted only for 0.4 V in FIG. 23).

Referring to FIG. 23, during the first 10 s after switching off the hydrogen flow to the anode, the current stayed at the same level as the current recorded under constant hydrogen flow. Then it decayed to zero after 100 s. During the first 40 s, gas still evolved from the cathode, causing visible “spikes” at the beginning of the decaying line in FIG. 23. This current decay to zero after turning off the hydrogen flow to the anode corresponds to the last hydrogen/protons being consumed. In other words, the currents from both reactions, HOR (anode) and HER (cathode), dwindle and are no longer present after the remaining hydrogen is consumed at the anode and protons are no longer delivered to the cathode for the reduction. The current observed at the 100 s mark after switching off the hydrogen flow to the anode is likely due to gas still present in the tubing, gas soluble in sulfuric acid, and protons in train between the electrodes.

Electrochemical Activation of the Electrodes with Pure Hydrogen

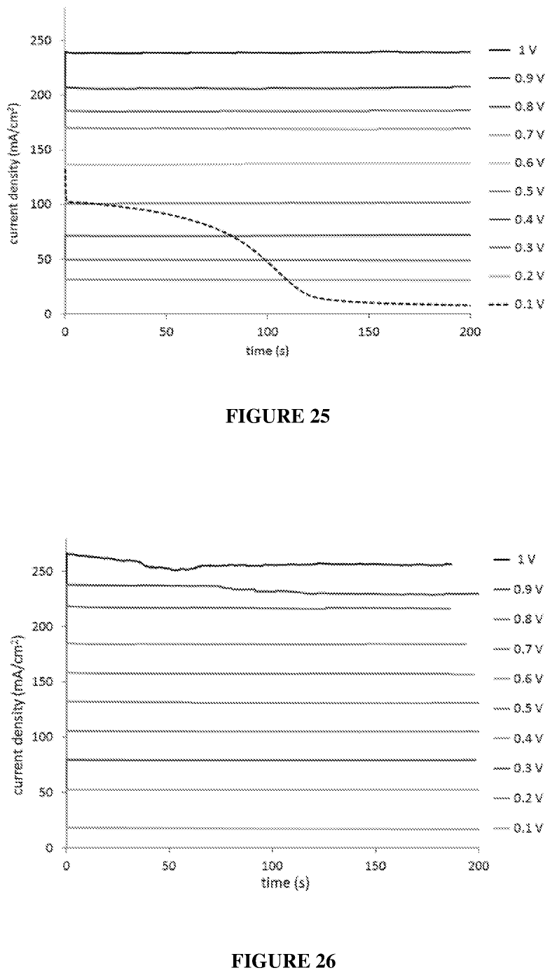

After this first examination of the cell responses using a three-electrode setup, further tests were performed with a two-electrode configuration, with the potential controlled against the cathode. Measurements were performed similarly to the previous example, under potentiostatic conditions, with pure hydrogen supplied to the anode compartment. Potentials between 0.1 V and 1 V were applied and the current was measured over 3 min periods. Two sets of measurements were performed. Chronoamperograms of the first (Run 1) and second (Run 2) set of measurements are illustrated in FIGS. 25 and 26, respectively. The gas produced at the cathode compartment was collected during the measurements.

Recovered hydrogen Hᵣ was collected from the cathode during this test and the cell efficiency was then calculated from eq. 5, with the results provided in the table of FIG. 24,

$${η}_{cell} = \frac{Hr}{Hp} * 100 [ \% ] \qquad ( eq . 5 )$$

where η_{cell} is cell efficiency calculated from the recovered hydrogen Hᵣ and theoretically produced hydrogen Hₚ on the basis of the current intensity.

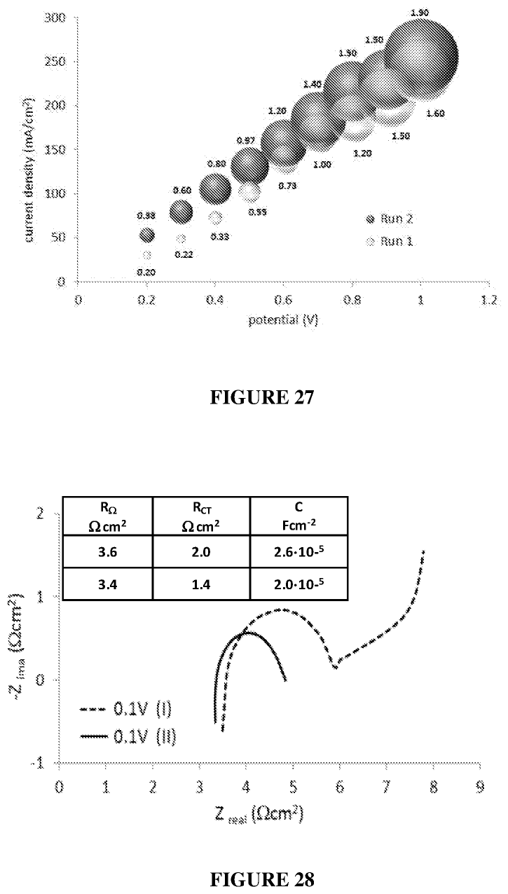

Referring to FIG. 27, there is illustrated a plot of current density versus potential where the size of the illustrated bubbles corresponds to the recovery rate of hydrogen gas (in millilitres per minute) for the first (Run 1) and second (Run 2) set of measurements.

It was noticed that the current and the amount of recovered hydrogen was lower during the first potentiostatic set of measurements, called here Run 1 (shown in FIG. 25), when compared to the second potentiostatic set of measurements, called here Run 2 (shown in FIG. 26). This difference was particularly clear at lower current density. Additionally, the very first chronoamperogram at 0.1 V in Run 1 (FIG. 25, dashed line) always started from a higher current (−100 mA/cm²) and gradually decreased to a steady state current (6-7 mA).

To understand this phenomenon and the origin of the cell improvement after electrochemical activation, electrochemical impedance spectroscopy (EIS) was undertaken. Two measurements, illustrated in FIG. 28, were compared: (I) was taken after establishing the hydrogen flow at the anode (open circuit potential at −0.8V) and at the very first applied potential of 0.1 V (before Run 1, FIG. 28, dashed line); and (II) after two sets of electrochemistry measurements, returning again to the potential 0.1 V (after Run 2, FIG. 28, solid line).

The Nyquist plots of both measurements, illustrated in FIG. 28, show some differences. In general, the intercept of the arc with the real axis at the high-frequency end represents the total ohmic resistance R_{Ω}, which is the sum of the contributions from uncompensated contact resistance and the ohmic resistance of cell components, such as electrolyte (electrolyte ionic resistivity) and electrodes. After electrochemical activation this resistance (R₁₀₆) decreased only slightly from 3.6Ω to 3.4Ω(5%). The second intercept with the real axis, is the sum of the ohmic resistance and the charge transfer resistance R_{Ω}+R_{CT} at the electrodes (called also kinetic resistance). Only one arc was present on the spectrum but it represents both electrodes. It is clear that, after activation, the charge transfer resistances of the HOR and HER significantly decreased from 2.0 Ωcm² to 1.4 Ωcm² (30%).

One more difference was observed between the two plots in FIG. 28. When the potential of 0.1 V was applied for the first time (FIG. 28, dashed line), an additional response at the lower frequency part was present. This is an indication of a diffusion-controlled process, limited by proton diffusion to the anode. However, after the cell was tested electrochemically and the flux of the protons was established, this diffusion resistance disappeared.

A higher capacitance (C; 2.6·10⁻⁵ F cm⁻² versus 2.0·10⁻⁵ F cm⁻²) at the electrode interfaces at the beginning of cell operation, is also in agreement with the higher current recorded when the first-time potential was applied (FIG. 25, dashed line). The origin of this current is not clear. It may be a simple result of electrical double-layer rearrangement at the electrode interfaces and activation of the so-called three-way solid-liquid-gas interfaces that are formed in gas diffusion electrodes. It may be also an oxidation of impurities. We can conclude from EIS that electrochemical activation of the electrodes reduced all resistances in the cell. Significant improvements in the charger transfer resistance at the electrodes was, especially, noted. This can be the combined effect of improving the: (i) electron conducting paths upon applying the potentials (solid-both electrodes, electrochemical cleaning, increased active surface area), (ii) ion-conduction path (liquid-improved wettability, establishing diffusion) or (iii) more efficient gas penetration (anode), or gas evolution (cathode) as the microstructure of the electrodes improved.

The solubility of hydrogen in H₂SO₄ may also contribute to the lowering of the cell performance at the beginning. It has been reported that the solubility of hydrogen in 1 M H₂SO₄ at 30° C. is 14.3 ml/dm³ (see: Ruetschi, P.; Amlie, R. F. J. Phys. Chem. 1966, 70, 718), which will initially consume evolved hydrogen of around: 50% at 10 mA/cm³, 25% at 20 mA/cm³ and 17% in 30 mA/cm³ (cell volume 2.7 cm³). This solubility may further affect the amount of hydrogen evolved until the solution of sulfuric acid becomes saturated with hydrogen. This may explain the apparent low cell performance at the lower current density (e.g. Run 1 vs. Run 2 in FIG. 24). These conclusions are supported by the fact that the cell efficiency was close to 100% across the entire current density range during the second set of electrochemical tests.

Hydrogen Mixtures with the Methane in the Range of 25%-100%

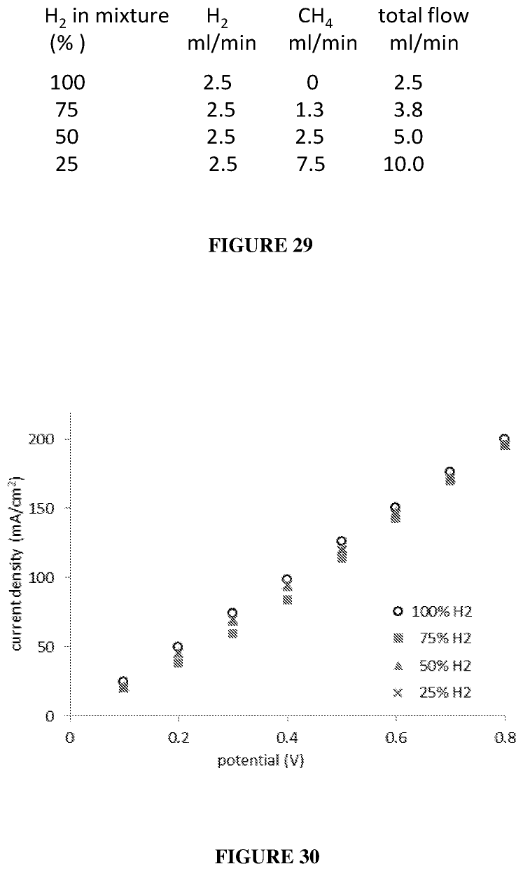

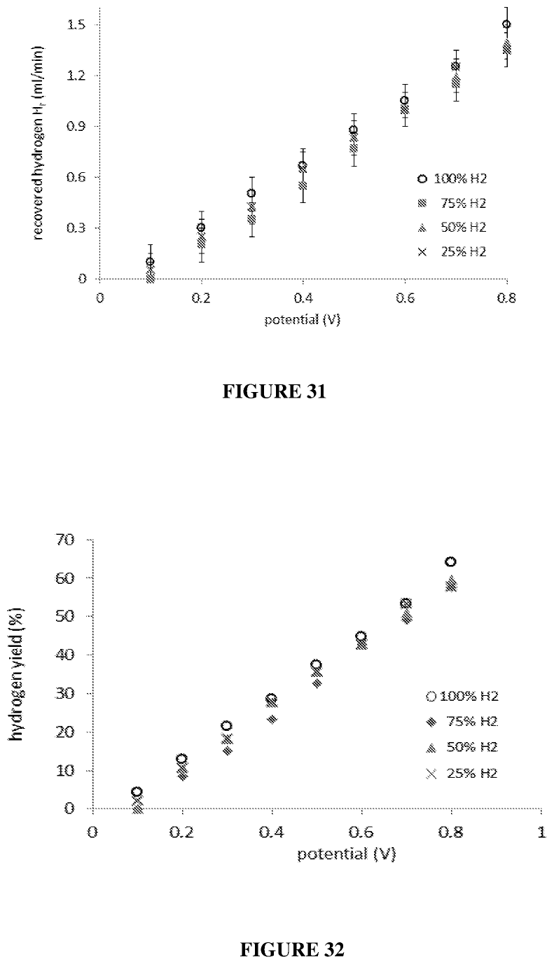

Recovery of pure hydrogen from mixtures with methane was first attempted with mixtures of 75%, 50% and 25% hydrogen. Experiments were performed, as described previously, in a two-electrode system. Instead of supplying the anode of the cell with pure hydrogen, a gas mixture of hydrogen and methane was provided. The total gas flow rate for various hydrogen concentrations was varied to maintain a constant hydrogen flow rate at 2.5 ml/min. FIG. 29 illustrates a table of the gas flow rate for various hydrogen concentrations. As illustrated in FIG. 30, the current was measured for potentials varying between 0.1 V and 0.8 V in order to avoid cell starvation. FIG. 31 illustrates the recovery rate of hydrogen gas generated and collected at the cathode was collected.

No difference in the recorded current and the amount of hydrogen collected from the cathode was observed when comparing pure hydrogen with methane mixtures in the 75-25% range.

Hydrogen yield η_{H} is defined according eq. 6, as the ratio between hydrogen recovered Hᵣ from the cathode and the hydrogen fed H_{f} to the anode

$${η}_{H} = \frac{Hr}{Hf} * 100 [ \% ] \qquad ( eq . 6 )$$

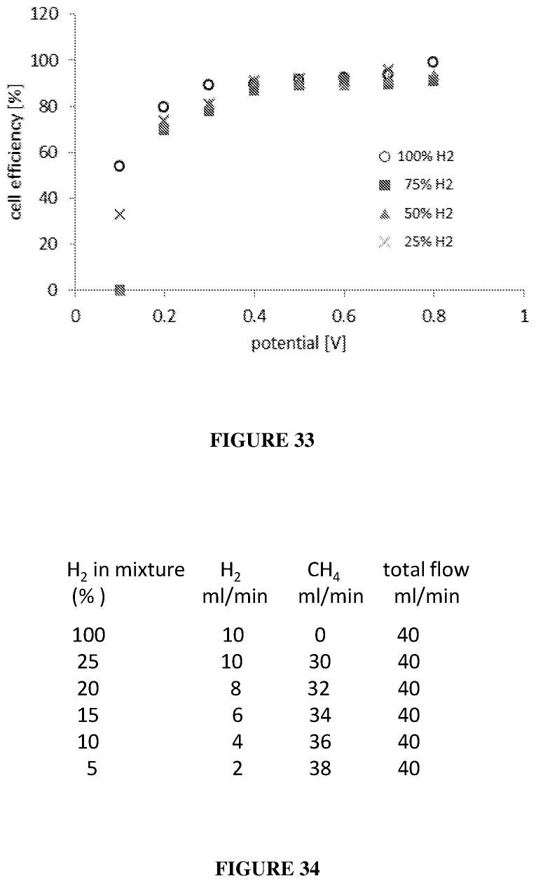

FIG. 32 illustrates the hydrogen yield, which increased linearly with applied potentials, approaching 64% for pure hydrogen at 0.8V and 57-59% for all hydrogen/methane mixtures. The equivalent cell efficiency was 80-98% for pure hydrogen and 69-93% for the all gas mixtures at the potential range 0.2V to 0.8V, as illustrated in FIG. 33. This outcome is already an improvement upon the electrochemical hydrogen purification based on conventional technologies, which cannot efficiently extract hydrogen from dilute sources.

Hydrogen Mixtures with the Methane in the Range of 25%-5%

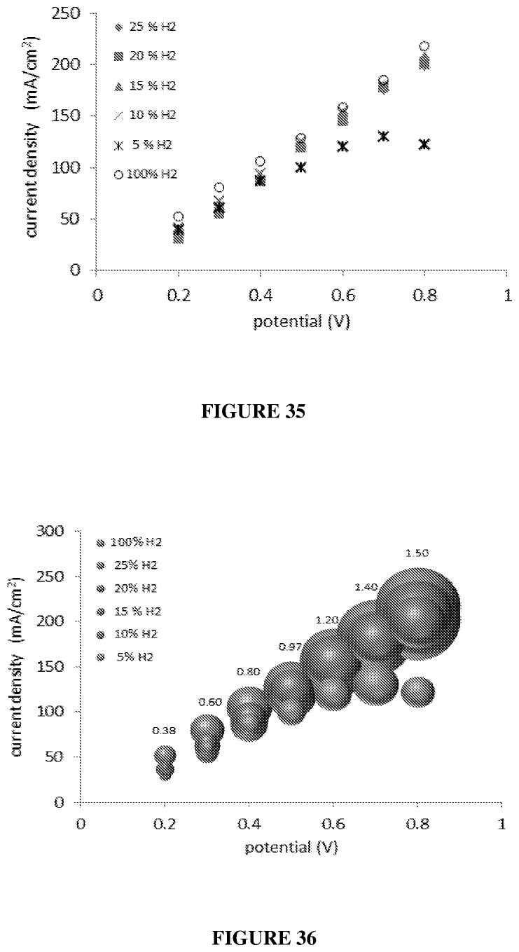

Still more dilute mixtures of hydrogen and methane (25%-5%) were then investigated. In this set of experiments, the total flow of the gas mixture was kept constant at 40 ml/min. FIG. 34 illustrates a table of the gas flow rate for various hydrogen concentrations. FIGS. 35 and 36 illustrate measured current-potential curves obtained for the different gas mixtures. When a potential between 0.2 V and 0.8 V was applied, the current proved to be identical for mixtures of 25%, 20%, 15% and 10% hydrogen. In the case of a 5% mixture, the current recorded between 0.2 V and 0.4 V followed the previous trend but above 0.4 V it started to decay as cell starvation commenced.

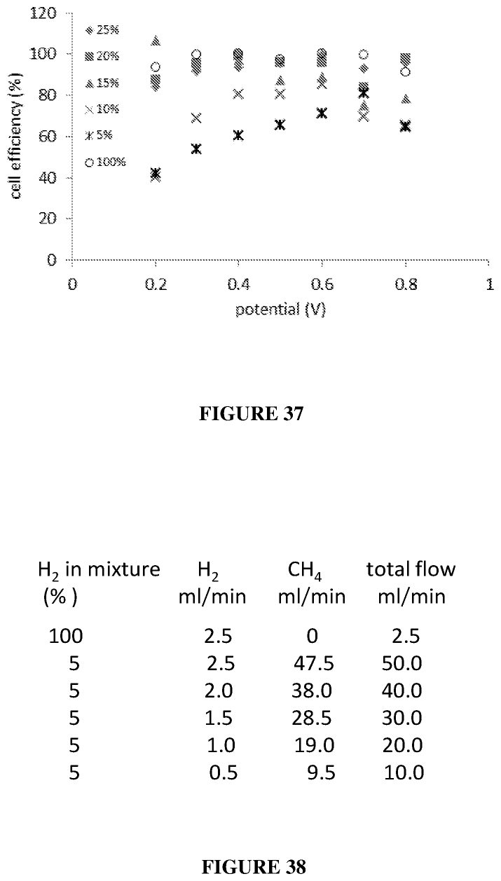

Referring to FIG. 37, the cell efficiencies for 25% to 15% mixtures are similar to the 75%-25% mixtures. The 10% mixture yielded optimum efficiencies of 80-85% between 0.4 V and 0.6 V, while the 5% mixture operated at 71% efficiency at 0.6 V, approaching the lowest value of 40% at 0.2 V.

### Probing 5% Hydrogen in Methane

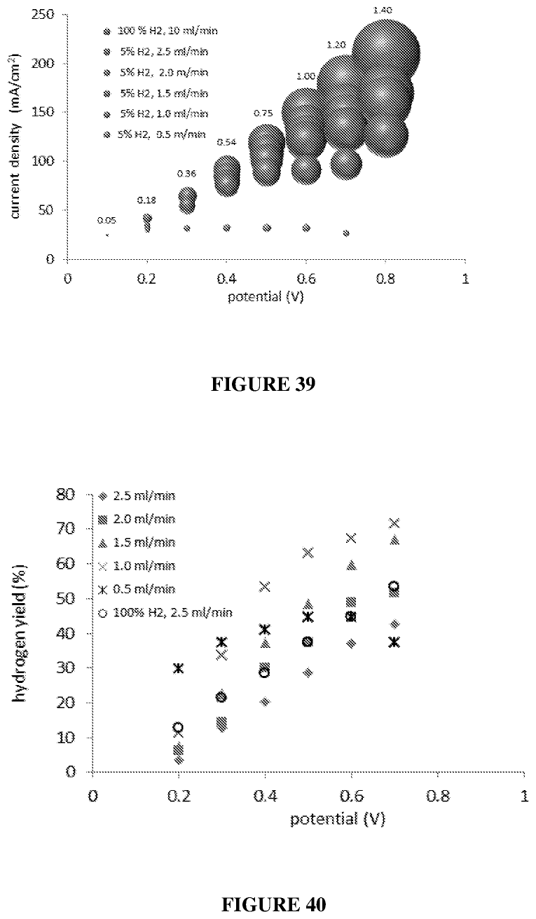

Based on the above results, it was clear that the 5% mixture suffered from lower performance at higher current densities, which indicated a problem with cell starvation. Cell starvation occurs when hydrogen at the anode is consumed faster than it is supplied. To investigate in more detail and optimise the performance of the cell with the 5% mixture, measurements were undertaken with different flow rates to the anode (0.5 ml/min to 2.5 ml/min). FIG. 38 illustrates a table of gas flow rate to the anode. As evidenced by the current-potential plot illustrated in FIG. 39, the amount of hydrogen fed into the anode is important for proper maintenance of the cell. When compared to pure hydrogen supplied at the 2.5 ml/min, the mixture of 5% hydrogen, which is delivered to the cell at the same flow rate suffers only a small decrease in the current and gas production at the cathode. However, reducing the flow of hydrogen to the anode has a clear impact, causing a decrease in the current and in the amount of gas produced at the cathode. At the lowest flow rate of 0.5 ml/min, the current and evolved gas reached a steady state condition.

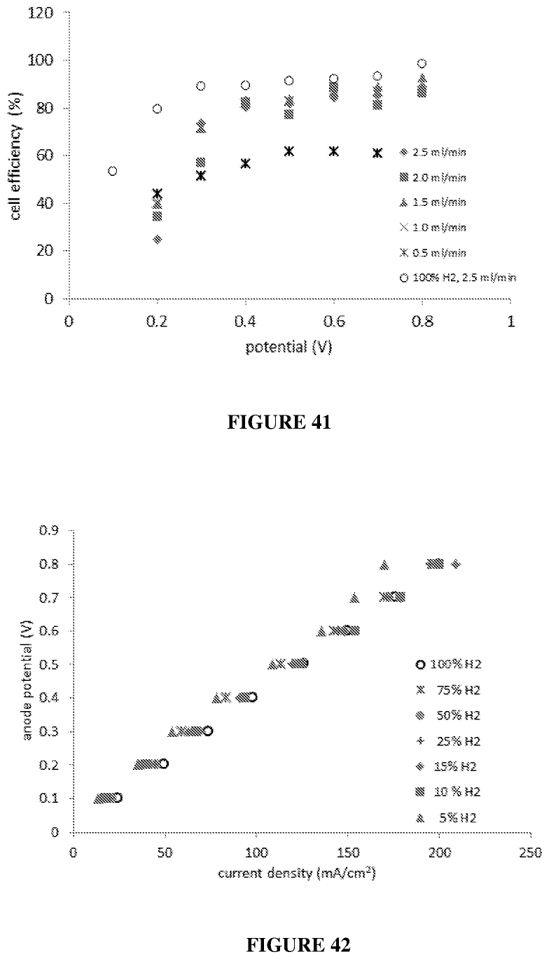

The hydrogen yield η_{H} measurements illustrated in FIG. 40 show an increasing-yield trend with slower flow to the anode, reflecting a more efficient consumption of the supplied hydrogen. Aη_{H} of 72% was achieved for a flow of 1 ml/min at 0.7 V. FIG. 41 illustrates plots of the measured cell efficiencies with varying hydrogen flow rates to the anode.

### Cell Characteristics

FIG. 42 illustrates the potentials at the anode versus the current density for different gas mixtures, from pure hydrogen to 5% of hydrogen in methane. Plots of this type are known as polarization curves. The linear nature of this plot indicates that resistive (i.e. IR) losses, due to the cell resistance, dominate the cell overpotential in this region (20-200 mA/cm²).

Cell resistance was estimated from the slope of the polarization curves for mixtures having between 100% and 10% hydrogen in methane (3.9±0.2Ω), as well as for 5% hydrogen in methane (4.3Ω). When comparing to the equivalent polarization curves of PEM cells operating with dilute hydrogen, it is important to notice that the resistance of the PEM cell significantly increases as the amount of the hydrogen in the gas mixture decreases. By contrast, in the present system only a small change of 0.4Ω was measured for the 5% hydrogen mixture.

The ohmic resistance R_{Ω}, determined from impedance measurement illustrated in FIG. 28 to be 3.4Ω, is slightly lower than the resistance calculated from the polarization curves. As reported in the literature (see: Cooper, K. R.; Smith, M. J. Power Sources 2006, 160, 1088), an over-estimation of the ohmic potential drop may arise from using polarization curves due to the inherent difference in the response of a porous electrode with non-negligible resistance, to a large voltage perturbation (polarization curve) compared to a small perturbation (as in an impedance measurement).

The ohmic resistance of the supporting electrolyte depends on the anode-to-cathode spacing or the charge-transport length (d), cross-sectional area of charge transport (A) and the ionic conductivity (σ) (eq. 7)

$${E}_{el} = \frac{d}{σ A} \qquad ( eq . 7 )$$

To obtain more information about why the liquid cell works successfully with even very dilute mixtures of hydrogen, further impedance measurements were undertaken.

Mixtures of 50%, 25%, 10% and 5% were examined within the potential range 0.1 V to 0.4 V and compared to the results achieved with pure hydrogen.

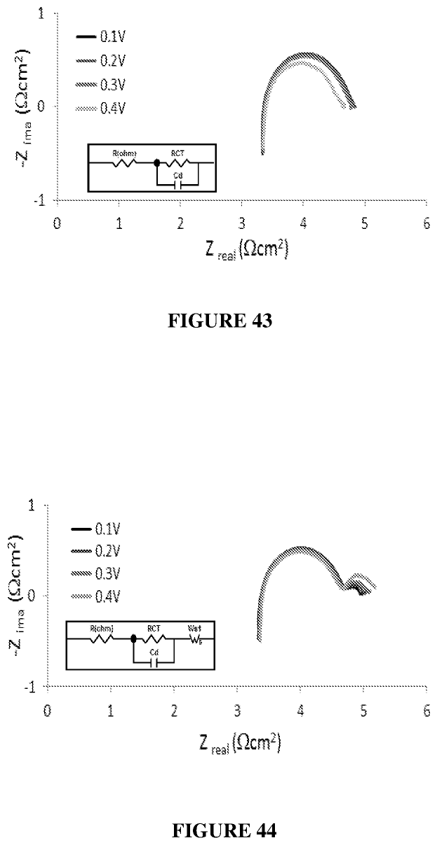

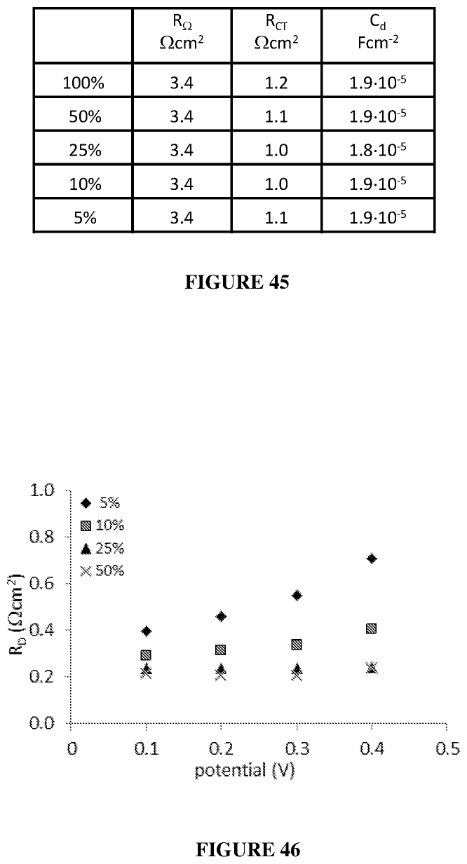

Nyquist plots for 100% and 5% mixture are shown in FIGS. 43 and 44, respectively. An equivalent circuit diagram, illustrated in the inset of FIG. 43, was used to fit the data for pure hydrogen. The same circuit, extended with a Warburg element to fit Nernst impedance (finite diffusion), was used to fit the data for all 5% hydrogen-methane mixtures, as illustrated in FIG. 44. The results are presented in the table of FIG. 45.

No differences were observed for the ohmic resistance R_{Ω}, charger transfer resistance R_{CT} and capacitance at the electrodes for all of the mixtures and pure hydrogen at the investigated potentials. However, all mixtures showed the presence of diffusion resistance R_{D} at the lower frequency part. Plots of the diffusion resistance values calculated for different cell voltages are illustrated in FIG. 46. These plots illustrate some trends of diffusion resistances: (i) diffusion resistances increase with the extent of dilution of hydrogen in the mixture, and (ii) increase with the applied potentials. However, the resistances are relatively small, being below 1 Ωcm².

The origin of the efficiency of the present cell therefore appears to fundamentally derive from the solid-liquid interface between the (solid) porous gas layer electrodes and the (liquid) electrolyte, as well as the high proton conductivity of the acid electrolyte. This interface and electrolyte clearly exhibits an extraordinary efficiency for selective extraction of hydrogen, conversion of the hydrogen into protons, and transfer of those protons via the proton conducting liquid phase to the other electrode. The efficiency of these elements for the reaction very substantially exceeds the capability of the comparable alternative technologies.

### Energy Consumption of the Cell Under Operational Conditions Using a 5% Hydrogen in Methane Blend

The power (in W) required by a cell of the above type is the product of its voltage (in V) and current (in A). The energy consumption of the cell (in W h) is obtained by multiplying its power usage by the time over which the power is applied (in h). To determine the energy consumption under operational conditions, it is necessary to select the lowest reasonable voltage at which practically useful hydrogen fluxes are achieved by the cell, with accompanying high cell efficiencies and hydrogen yields. The data in FIG. 39 and FIG. 40 for a 5% hydrogen blend suggest that these conditions may be best met using 5% hydrogen supplied at 1 ml min⁻¹ at 0.40 V. A 1 cm² cell operating under these conditions consumes 75 mA (FIG. 39) with a hydrogen yield of 55% (FIG. 40). Accordingly, the power required by such a 1 cm² cell would be 0.40×0.075=0.03 W. Over 1 h, its energy consumption would be 0.03 W×1 h=0.03 W h, or 3×10⁻⁵ kW h. During that time, it would generate: 55%×1 ml min⁻¹=0.55 ml min⁻¹ of H₂, or 33 ml h⁻¹ of H₂. According to the ideal gas law, at 25° C. and 1 atm pressure, 1 kg of H₂ equates to 12,145 L.27 Thus, the cell would generate 33/(12,145×1000)=2.717×10⁻⁶ kg of H₂, giving it an energy consumption, under operational conditions, of: 3×10⁻⁵/2.717×10⁻⁶=11.04 kW h kg⁻¹ H₂.

The theoretical minimum energy required to generate 1 kg of H₂ is 39.41 kW h kg⁻¹. In practice however, at the overall system level, large electrolyzers (e.g. 1000 kg H₂ per day) require 49-53 kWh kg⁻¹ H₂ and very large electrolyzers of the type planned for commercial Power-to-Gas installations (50 000-200 000 kg H₂ per day) are expected to require 43-48 kW h kg⁻¹ H₂. Small-scale electrolyzers (1-20 kg H₂ per day) are generally more energy intensive because of the high cost of active cooling at small scale, requiring 70-90 kW h kg⁻¹ H₂.

### Illustrative Potential Future Applications Utilizing Power-to-Gas

In order to illustrate the potential of the above technology when combined with Power-to-Gas technology, we now consider some possible scenarios.

The above results suggest that, if the above cell used natural gas enriched with 5% hydrogen (i.e. a Power-to-Gas blend), it may be possible to leverage the economies of scale of Power-to-Gas electrolyzers in order to generate small amounts of pure hydrogen for only an additional ca. 11.04 kW h kg⁻¹ H₂. That is, using an adapted cell coupled to a Power-to-Gas pipeline, it would potentially be possible to generate hydrogen locally in quantities of 1-20 kg per day at a total energy consumption, including the upstream Power-to-Gas electrolyzer, of ca. 54-59 kW h kg⁻¹. This would be less than a typical small-scale electrolyzer.

More pertinently however, the cost of the extracted hydrogen would likely also be notably lower than could be achieved with a small scale electrolyzer. This would be for the following reasons. The principle of Power-to-Gas is to use renewable electricity that is inexpensively, or even negatively priced (because there is a low demand for it), to manufacture hydrogen that is injected into a natural gas pipeline. The pipeline hydrogen is likely to cost end-users no more than the equivalent volume of natural gas. At present US spot prices of USD $3.00/1000 cubic feet of natural gas (where 1000 cubic feet=28,317 L), the volume of gas in 1 kg of hydrogen extracted from a Power-to-Gas pipeline, would cost USD $1.29. To that would have to be added the cost of extracting the hydrogen from the pipeline. Using the present average US industrial electricity price of 7.25 US cents per kW per h, the cost of extraction could potentially be 7.25×11.04=80 US cents per kg H₂. The total cost of the hydrogen would then be ca. USD $1.29+$0.80=USD $2.09 per kg H₂, which is roughly half the 2015 DOE target for commercial electrolyzers of $3.90 per kg H₂.

This analysis does not, of course, take account of all of the potential operational costs, such as capital costs, distributor margins, and the like. But, on the other hand, it also does not consider savings that could arise from using inexpensively or negatively priced excess renewable electricity for the hydrogen extraction process. In effect, low-cost hydrogen would be produced by harnessing the excess renewable power from wind- or solar-generators that would normally be turned off when demand was low, or whose output would normally be discarded at times of low demand. This low-cost hydrogen would, further, be distributed, using an existing gas distribution system that is widespread and readily available to end-users.

What could the extracted hydrogen be used for? As noted earlier, the above H₂-methane cell uses 0.05 mg Pt per cm² on each electrode. If an adapted, H₂-natural gas cell employed the same loadings and contained a total of 10 g of Pt, which is about the amount of Pt in an automobile catalytic converter, then the cell would have 10 m² of cathodes and 10 m² of anodes. Based on FIG. 39 and FIG. 40, such a cell could potentially generate 6.5 kg of H₂ per day at 0.4 V, which is roughly the amount of hydrogen required to refuel a hydrogen-based fuel cell electric vehicle (FCEV). The 2025 target for Pt in the powertrain of FCEVs is also 10 g. According to an industry rule of thumb, 6.5 kg of hydrogen would allow the FCEV to travel 650 km. CO₂-free vehicle transportation using renewable hydrogen could thereby potentially be enabled. That is, renewable energy could be converted to and harnessed as a transportation fuel. Given that the cost of renewable energy is declining rapidly, Power-to-Gas and associated technologies could potentially become a platform for a future hydrogen economy.

### Summary: Gas Extraction Cell

Therefore, some of the advantages of the example electrochemical cells tested can be summarised as follows:
1. Cells operated with the 10%-100% mixtures of hydrogen and methane behave the same as cells fed with pure hydrogen. Close to 100% retrieval efficiency can be achieved in a single step.
2. Electrochemical purification of the hydrogen can be performed from methane mixtures diluted to 5% hydrogen by volume. The cell retrieval efficiency at 0.4 V and 0.7 V were then 82% and 89%. A best hydrogen yield of 72% was achieved with a flow of 1 ml/min and a potential of 0.7 V. In respect of the amount of hydrogen fed into the cell, cell starvation was not observed and successful operation proved possible from even very dilute mixtures, such as 5%.
3. At low levels of hydrogen in methane (e.g. 5%), mass transport comprises the key limitation. This limitation can, however, be readily overcome by simply increasing the flow rate of the hydrogen-methane mixture through the cell.
4. Electrochemical conditioning of the cell improved its performance across a spectrum of current densities, but especially in the lower current density range.
5. Electrochemical liquid purification cells of this type do not suffer from the massive, diffusion-controlled, mass-transport limitations exhibited by PEM. This allows for efficient extraction of hydrogen from very dilute mixtures.
6. The origin of the efficiency of the present cell derives, fundamentally, from the intrinsic efficiency of the solid-liquid interface between the catalyst-coated gortex electrodes and the liquid electrolyte, as well as the high proton conductivity of the acid electrolyte. This interface and electrolyte is substantially more effective than the comparable solid-solid interface and proton conductor in PEM technology.

### Example 3: Fabrication of an Example Fuel Cell/Gas Extraction Cell

### Materials Used for Making an Example Fuel Cell/Gas Extraction Cell

The following materials were employed for making the example fuel cell and gas extraction cell (Supplier): Carbon black (AkzoNobel), 20% Pt—Pd on Vulcan XC-72 (Premetek Co. # P13A200), Poly(tetrafluoroethylene) (PTFE) (60 wt. % dispersion in alcohols/H₂O; Sigma-Aldrich #665800), KOH 90%, flakes (Sigma-Aldrich #484016), Ni mesh, 200 LPI (Precision Eforming LLC of Cortland N.Y.) (cleaned using isopropyl alcohol prior to use), and copper tape with 6.35 mm width (3M). Polypropylene-backed Preveil™ expanded PTFE (ePTFE) membranes with 0.2 μm pore size, produced by General Electric Energy were used in all experiments.

Preparation of Catalyst-Coated ePTFE Substrate

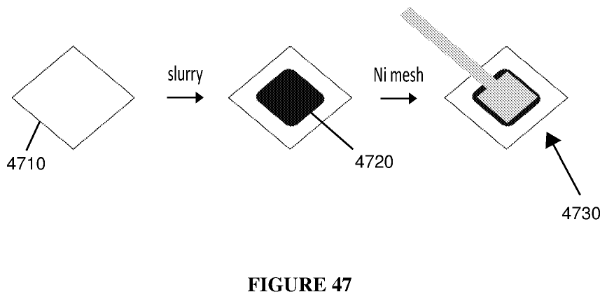

Referring to FIG. 47, there is illustrated an example method for making a catalyst-coated porous gas layer membrane, or substrate, comprising a porous gas layer such as an ePTFE membrane, a catalyst slurry, and a metallic mesh. There is shown polypropylene-backed ePTFE membrane 4710 (shown as PTFE side up), application of slurry to form catalyst slurry 4720, and application of a Ni mesh to form membrane/catalyst/mesh assembly 4730. The catalysts were prepared as a slurry, by weighing out catalyst and carbon black into a 20 mL vial, purging with N₂ for about 2 min to remove air, then adding isopropyl alcohol (IPA) and water. The mixture was sheared using a homogeniser (IKA T25) with dispersing element (IKA S 25 N-18 G) at 10,000 rpm for 5 min. PTFE aqueous dispersion was then added dropwise with continuous shearing. After all of the PTFE was added, shearing at 10,000 rpm was continued for another 5 min.

The resulting catalyst slurry was drop-cast onto the PTFE side of the ePTFE membranes (24 mm×24 mm membrane pieces) and spread out into a square shape measuring about 12 mm in height and about 12 mm in width, as shown in FIG. 47. Nickel mesh, which had been laser cut to dimensions 12 mm×12 mm for the square part with an attached 4 mm×34 mm neck, was laid on top of the wet slurry and pushed down gently using tweezers to ensure even wetting. Membrane/slurry/mesh assemblies were allowed to dry under ambient conditions.

The dried membrane/slurry/mesh assemblies were compacted using a double-roll mill, having metal rollers. After drying, membrane/slurry/mesh assemblies were rolled three-times through a gap equal to 0.1 mm plus the mesh thickness. For the meshes used, a roller gap of 0.1 mm+0.15 mm=0.25 mm was set. As the membrane was about 0.2 mm thick, the membrane/slurry/mesh assemblies were compressed by 0.1 mm during rolling.

After rolling, the membrane/slurry/mesh assemblies were weighed. These values were used, together with the weight of the membrane (pre-measured before applying catalyst) and the weight of the mesh (pre-measured before use) to calculate the catalyst loading. The catalyst loading was precisely determined for each electrode; the average was 1.6 g/m² (for the fuel cell) or 0.5 g/m² (for the gas extraction cell).

### Electrode Preparation

Electrodes were prepared by mounting them inside a plastic (PET) laminate that became rigid after passing through a stationery-store laminator.

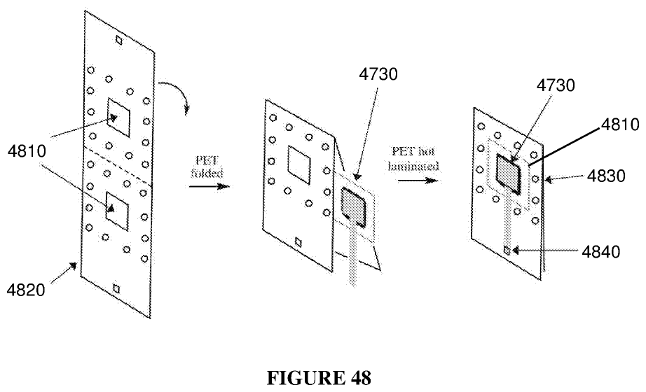

After weighing, each dried and rolled membrane/slurry/mesh assembly was mounted in a pre-cut, folded PET laminate of the type available in stationery stores. The laminate was first cut, using a laser cutter, to a design depicted in FIG. 48, which included a 1 cm×1 cm window in each side. After folding over, the membrane/catalyst/mesh assembly was placed inside the folded-over laminate such that the membrane/catalyst/mesh was located in the middle of the window (as depicted in FIG. 48). Thus, FIG. 48 illustrates windows 4810 cut into PET. PET laminate 4820 is a cut-out as shown. The PET is folded and membrane/catalyst/mesh assembly 4730 is inserted into the folded-over PET. The PET is hot laminated and the membrane/catalyst/mesh assembly 4730 is located between laminate windows 4810 to form laminated electrode 4830. Conductive copper tape is pasted over exposed Ni mesh to provide electrode contact 4840. The resulting assembly was then fixed in place by carefully passing it through a commercial hot laminator of the type found in stationery stores. In this way, both sides of the catalyst-coated ePTFE membrane remained open and exposed, within the window in the laminate. A small piece of conductive copper tape was attached over the terminus of the neck of the Ni mesh as an electrode contact (see FIG. 48).

The 10 mm×10 mm window in the laminate defined the geometric area of the fuel cell to be 1 cm².

### Cell Construction

A test cell was custom built to match the dimensions of the laminated electrodes.

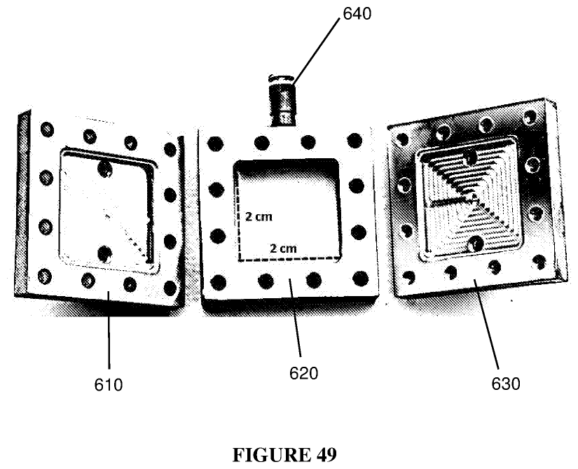

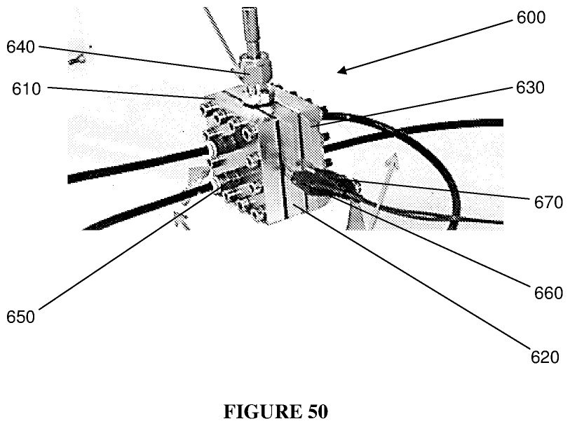

FIGS. 49 and 50 depict photographs of such a cell, showing how the laminate-mounted electrodes were placed between the three components of the cell, which were then bolted together using twelve, edge-arrayed screws/bolts. Example cell 600 includes first side section 610, middle section 620 and second side section 630, for example made of metal such as stainless steel, which can be bolted together. First gas regulator 640 transfers gas into/from an electrolyte chamber of the cell. Second gas regulator 650 transfers gas into/from a gas chamber of the cell. First electrical connection 660 attaches to one electrode and second electrical connection 670 attaches to another electrode. The cell can be filled, or partially filled, with an electrolyte and a cell voltage applied over the electrodes, whilst applying a pressure to the liquid electrolyte chamber via regulator 640.

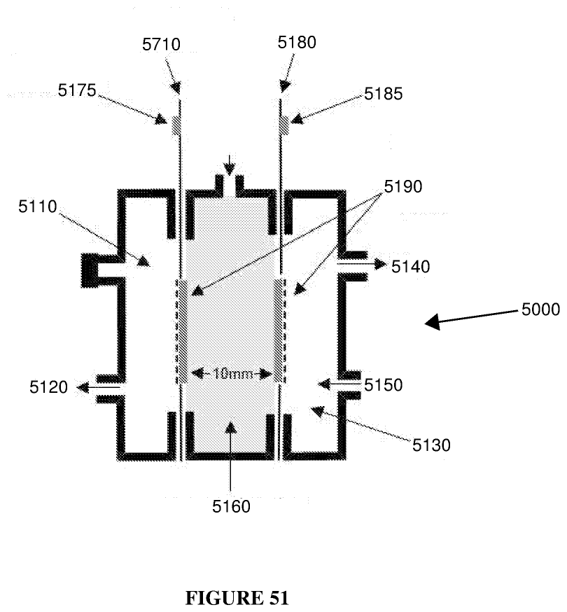

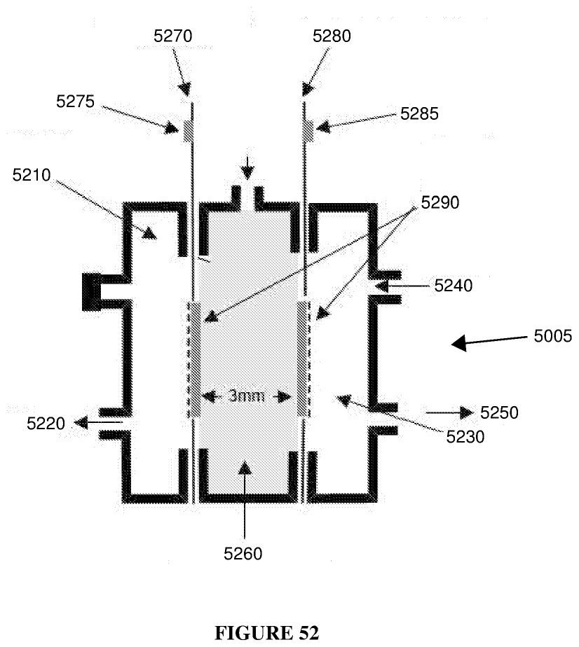

FIG. 51 illustrates a cross-sectional schematic of a custom-built fuel cell 5000, showing electrical and gas connections. FIG. 52 illustrates a cross-sectional schematic of a custom-built gas extraction cell 5005, showing electrical and gas connections. Each laminate-mounted electrode was placed in the cell such that the exposed, windowed catalyst-mesh side faced inwards, toward the facing electrode, and the uncoated back of the ePTFE membrane faced outwards. The cell was assembled using a 3 mm spacer (FIG. 52) or a 10 mm spacer (FIG. 51) between the electrodes. The gas connections were made using gas-tight fittings. The central cavity of the cell was filled with 6 M KOH (FIG. 51) or was filled with 1 M H₂SO₄ (FIG. 52).

Referring to FIG. 51, there is shown hydrogen gas chamber 5110 with hydrogen gas outlet 5120. Oxygen gas chamber 5130 has oxygen gas outlet 5140 and oxygen gas inlet 5150. Aqueous electrolyte 5160, for example 6 M KOH, can be introduced by electrolyte inlet 5165. Laminate-mounted cathode 5170 has a copper tape electrical contact 5175. Laminate-mounted anode 5180 has a copper tape electrical contact 5185. Mounted ePTFE membranes 5190 have the windowed catalyst-mesh facing the aqueous electrolyte 5160 and the back of the ePTFE facing the respective hydrogen gas chamber 5110 or oxygen gas chamber 5130.

Referring to FIG. 52, there is shown hydrogen gas chamber 5210 with hydrogen gas outlet 5220. Gas mixture chamber 5230 has gas mixture inlet 5240 and gas mixture outlet 5250. Aqueous electrolyte 5260, for example 1 M H₂SO₄, can be introduced by electrolyte inlet 5265. Laminate-mounted cathode 5270 has a copper tape electrical contact 5275. Laminate-mounted anode 5280 has a copper tape electrical contact 5285. Mounted ePTFE membranes 5290 have the windowed catalyst-mesh facing the aqueous electrolyte 5260 and the back of the ePTFE facing the respective hydrogen gas chamber 5210 or gas mixture chamber 5230.

### Reactant Gases and Electrochemical Testing

The hydrogen and methane used in the experiments were stored in high-pressure cylinders connected via suitable polymer tubing to the test fuel cell. In order to obtain the desired mixtures of hydrogen and methane, calibrated mass flow controllers were used (Aalborg, Stanton Scientific, 10 ml/min for H₂ and 50 ml/min for CH₄). The anode compartment of the fuel cell was fed with pure hydrogen or a mixture of hydrogen and methane, while a cylinder of O₂ gas was supplied to the cathode. The anode compartment of the gas extraction cell was fed with pure hydrogen or a mixture of hydrogen and methane, while pure hydrogen was collected at the cathode.

Electrochemical testing was carried out using a Biologic VSP potentiostat. The fuel cells were characterised by steady-state current-voltage (I-V) curves, chronoamperometry, and chronopotentiometry. In the fuel cell, the H₂ (H₂ and CH₄ mixture) electrode (anode) was connected as the working electrode and the O₂ electrode was connected as a combined auxiliary/reference electrode. Thus, all reported voltages are vs. O₂.

Electrochemical impedance spectroscopy (EIS) measurements were recorded at open circuit or at the constant current density of 10 mA/cm² conditions between 0.1 Hz and 200 kHz with an AC amplitude of 10 mV using a potentiostat (Bio-Logic Science Instruments). Spectra were analysed and fitted using Zview version 3.4.

It is to be understood that these example embodiments are not intended to be limiting and other configurations of electrochemical cells may fall within the spirit and scope of this application.

Although a preferred embodiment has been described in detail, it should be understood that many modifications, changes, substitutions or alterations will be apparent to those skilled in the art without departing from the scope of the present invention.

Optional embodiments may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

1. An electrochemical cell for extracting hydrogen gas from a gas mixture, the electrochemical cell comprising:
a first gas diffusion electrode comprising a first non-conductive hydrophobic porous gas layer and a first conductive catalyst;
a second gas diffusion electrode comprising a second non-conductive hydrophobic porous gas layer and a second conductive catalyst;
a liquid electrolyte in contact with the first conductive catalyst and the second conductive catalyst;
a first gas chamber adjacent to the first porous gas layer and containing a supplied gas mixture of hydrogen gas and a second gas; and
a second gas chamber adjacent to the second porous gas layer and containing pure hydrogen gas.

2. The electrochemical cell of claim 1, wherein the electrolyte is a proton-diffusing liquid.

3. The electrochemical cell of claim 1 or 2, wherein the electrolyte comprises an acid.

4. The electrochemical cell of claim 1 or 2, wherein the electrolyte comprises an acid in an aqueous solution.

5. The electrochemical cell of claim 3 or 4, wherein the acid is H₂SO₄.

6. The electrochemical cell of any one of claims 1 to 5, wherein the porous, liquid-impermeable material is expanded polytetrafluoroethylene (ePTFE).

7. The electrochemical cell of any one of claims 1 to 6, wherein the first conductive catalyst is part of a conductive layer separate from the first porous gas layer, the conductive layer contacting a surface of the porous gas layer in contact with the electrolyte.

8. The electrochemical cell of any one of claims 1 to 6, wherein the first catalyst or the second catalyst is directly supported on a portion of the respective porous gas layer.

9. The electrochemical cell of any one of claims 1 to 8, wherein the first electrode is structurally or compositionally different than the second electrode.

10. The electrochemical cell of any one of claims 1 to 9, wherein the first electrode is structurally and compositionally identical to the second electrode.

11. The electrochemical cell of any one of claims 1 to 10, where there is not any ion-permeable diaphragm or ionomer positioned between the first and second electrodes.

12. The electrochemical cell of any one of claims 1 to 11, wherein the electrochemical cell further comprises an electrical power source electrically connected to the first and second electrodes.

13. The electrochemical cell of any one of claims 1 to 12, wherein the first electrode is an anode at which hydrogen gas is consumed by oxidation, and wherein the second electrode is a cathode at which hydrogen gas is produced by reduction.

14. The electrochemical cell of claim 13, further comprising a mechanism for controlling the rate of supply of the gas mixture to the anode.

15. The electrochemical cell of any one of claims 12 to 14, further comprising a mechanism for controlling pressures in the first and second gas chambers.

16. The electrochemical cell of claim 15, wherein the second gas chamber has a fixed volume and a pressure regulator at an out-flow conduit.

17. The electrochemical cell of any one of claims 12 to 16, wherein the second gas chamber is sized and configured to store the pure hydrogen gas at a pressure greater than a pressure of the supplied gas mixture.

18. The electrochemical cell of any one of claims 12 to 16, wherein the pure hydrogen gas in the second gas chamber is at a steady pressure of at least 0.5 bar greater than a pressure of the supplied gas mixture.

19. The electrochemical cell of any one of claims 1 to 18, wherein the gas mixture comprises hydrogen gas and natural gas.

20. The electrochemical cell of any one of claims 18 to 19, wherein the gas mixture comprises hydrogen gas with a concentration of between about 5% and about 10%, by volume of the gas mixture.

21. A method of extracting hydrogen gas from a gas mixture, the method comprising the steps of:
supplying a gas mixture containing hydrogen gas and a second gas to a first gas chamber of an electrochemical cell, the first gas chamber containing a first electrode having a first non-conductive hydrophobic porous gas layer and a first conductive catalyst electrically connected to a first terminal;
applying an electric potential difference between the first terminal and a second terminal of the electrochemical cell;
wherein the second terminal is electrically connected to a conductive catalyst of a second electrode having a second porous gas layer and positioned in a second gas chamber; and
extracting a produced flow of pure hydrogen gas from the second gas chamber.

22. The method of claim 21, further comprising extracting the pure hydrogen gas at a pressure greater than a pressure at which the gas mixture is supplied to the first gas chamber.

23. The method of claim 21 or 22, wherein the gas mixture comprises natural gas mixed with the hydrogen gas.

24. The method of any one of claims 21-23, wherein the gas mixture has a hydrogen gas concentration of less than 10% by volume of the gas mixture.

25. A fuel cell for generating electrical energy from a gas mixture comprising hydrogen gas, the fuel cell comprising:
a first gas diffusion electrode comprising a first non-conductive hydrophobic porous gas layer and a first conductive catalyst;
a second gas diffusion electrode comprising a second non-conductive hydrophobic porous gas layer and a second conductive catalyst;
a liquid electrolyte in contact with the first conductive catalyst and the second conductive catalyst;
a first gas chamber adjacent to the first porous gas layer and containing a first supplied gas mixture of hydrogen gas and a second gas; and
a second gas chamber adjacent to the second porous gas layer and containing a second gas mixture.

26. The fuel cell of claim 25, wherein the electrolyte is an aqueous alkaline solution.

27. The fuel cell of claim 25 or 26, wherein the electrolyte comprises KOH.

28. The fuel cell of any one of claims 25 to 27, wherein the porous, liquid-impermeable material is expanded polytetrafluoroethylene (ePTFE).

29. The fuel cell of any one of claims 25 to 28, wherein each of the first and second electrodes comprises a catalyst, wherein the catalyst is coated on a surface in contact with the electrolyte.

30. The fuel cell of any of claims 25 to 29, further comprising a mechanism for controlling a rate of supply of the gas mixture to the first gas diffusion electrode.

31. The fuel cell of any one of claims 25 to 30, wherein the second gas mixture contains oxygen.

32. The fuel cell of claim 31, further comprising a mechanism for controlling a rate of supply of the second gas mixture to the cathode.

33. The fuel cell of any one of claims 25 to 32, wherein the first gas mixture comprises hydrogen gas and natural gas.

34. The fuel cell of any one of claims 25 to 33, wherein the first gas mixture comprises hydrogen gas in a concentration of between about 5% and about 10% by volume of the first gas mixture.

35. The fuel cell of any one of claims 25 to 34, wherein the first conductive catalyst is part of a conductive layer separate from the first porous gas layer, the conductive layer contacting a surface of the porous gas layer in contact with the electrolyte.

36. The fuel cell of any one of claims 25 to 34, wherein the first catalyst or the second catalyst is directly supported on a portion of the respective porous gas layer.

37. A method of generating electrical energy from a gas mixture, the method comprising:
supplying a first gas mixture containing hydrogen gas and a second gas to a first gas chamber of an electrochemical cell, the first gas chamber containing a first electrode having a first non-conductive hydrophobic porous gas layer and a first conductive catalyst electrically connected to a first terminal;
supplying a second gas mixture containing oxygen gas to a second gas chamber of the electrochemical cell, the second gas chamber containing a second electrode having a second non-conductive hydrophobic porous gas layer and a second conductive catalyst electrically connected to a second terminal; and
applying an electrical load between the first and second terminals.

38. The method of claim 37, wherein the first gas mixture has a concentration of hydrogen less than about 10%.

39. The method of claim 37 or 38, further comprising monitoring a concentration of hydrogen in the first gas mixture, increasing a rate of supply of the gas mixture to the first electrode in response to detecting a decreased concentration of the hydrogen gas in the first gas mixture.
